(19) United States
(12) Patent Application Publication
(10) Pub. No.: US 2015/0325138 A1
(43) Pub. Date: Nov. 12, 2015

(54) TEST PREPARATION SYSTEMS AND METHODS

(71) Applicant: Sean Selinger, Avondale, PA (US)

(72) Inventor: Sean Selinger, Avondale, PA (US)

(21) Appl. No.: 14/622,818

(22) Filed: Feb. 13, 2015

Related U.S. Application Data
(60) Provisional application No. 61/939,301, filed on Feb. 13, 2014.
(60) Provisional application No. 62/088,054, filed on Dec. 5, 2014.

(51) Int. Cl. G09B 19/00; G09B 7/00

(52) U.S. Cl. CPC G09B 19/00; G09B 7/00

(57) ABSTRACT

The present invention relates to systems and methods for improved test preparation and learning, including improving test-taking and time management skills for any test or performance on a test. Specifically, embodiments of the present invention are configured to provide users with pace analysis and tracking, adaptive real-time pacing feedback, and adaptive real-time exam tutoring, for both question content and test-taking strategies.

### CROSS-REFERENCE TO RELATED APPLICATIONS

This application claims benefit of priority from U.S. Provisional Patent Application No. 61/939,301, filed on Feb. 13, 2014, and U.S. Provisional Patent Application No. 62/088,054, filed on Dec. 5, 2014.

### BACKGROUND OF THE INVENTION

Standardized tests are used in many forms to certify competence and measure skill levels. The results of some of the standardized tests, such as the GMAT, GRE, SAT, TOEFL can have consequences including determining University admissions, career opportunities, and future earnings potential; thus, test-taker's invest a considerable amount of resources and effort to improve their scores on standardized tests.

Developed in the 1970's, Computer-Adaptive Tests (CAT) will deliver questions to match the user's skill level. When the user gets a question correct, the next question may be more difficult, and, when the user gets a question wrong, the next question may be less difficult. This has the benefit of making tests much shorter because they can quickly narrow in on the user's skill level. Further, adaptive tests can offer a broader and more accurate range of test results since there can be large number of either very easy or very hard questions. As a result, CAT tests are becoming a common norm for graduate admissions and are playing an increasing role in achievement tests that are mandated by educational agencies.

Despite the benefits, the CAT's user interface is awkward and not intuitive to use. Students may not go backwards on many of these tests (because it would interfere with adaptive question delivery). This means that student decisions are final, so students are often hesitant to “fold” and guess. On the other hand, if the student finishes the test early, he is stuck at the end of the test. These issues mean that, according to GMAC (Graduate Management Admissions Council), up to 15% of students finish with excessive time or run out of time at the end of the GMAT. These needless timing errors compromise predictability and diminish the effectiveness of the test. As a result, there is a demand for new technology to teach students how these adaptive tests function and how to properly take them.

There are four innovations in one that all synergize together to improve test taking; (1) Pacer Alerts/Student Feedback, (2) Pacer Graphs/Adaptive Graphs, (3) Dot Navigation, and (4) Experimental Mode and Analysis. The GMAT, like many other tests, uses a Computer Adaptive Test (CAT) algorithm to dynamically assess the test-taker's skill level throughout the test, and adapt the difficulty of future questions to the test-taker's performance on past questions. CAT is well-known in the art, having been in use for decades. The refined assessment of the test-taker's skill level is used by the CAT algorithm to choose the next question, and the process continues, such that in a CAT scenario, as the test progresses, the CAT algorithm's assessment of the test-taker's skill level is continuously updated, so that weaker test-takers receive easier questions, and stronger test-taker's receive more difficult questions. The questions generated by the CAT algorithm may not be the same for every test taker, and will ideally converge rapidly to the level of difficulty corresponding to the test-taker's dynamically measured skill level, such that a test-taker will see more questions close to their skill level than on a non-adaptive test. Objectives of a CAT may include, in addition to measuring the skill level of a test-taker, reducing test time, and increasing confidence in the measurement of the test-taker's skill level. CAT systems are usually based on the well known Item Response Theory (IRT), which incorporates item difficulty and test-taker response to model the probability that a test-taker at a particular ability level will answer a question with certain item parameters correctly. The probability of a test-taker's correct response is calculated by an Item Response Function (IRF), which may have different parameters varying by the type of model used. Item parameters may include: difficulty, such that test-taker's of lower ability will be less likely to answer correctly, and test-taker's of higher ability will be more likely to answer correctly; discrimination, the tendency or sensitivity of the item to identify test-takers as lesser or greater ability; and a parameter modeling the probability a test-taker will answer correctly by guessing. In order to implement a CAT test, some of the three IRT parameters for each question are needed. In related art, a specialist may be required to create a CAT exam from a group of questions. The specialist may be a psychometrician, and may analyze the questions according to multiple factors including relevancy or absence thereof, clarity or absence thereof, and bias; the psychometrician works to measure the difficulty level of the questions and to improve the questions. The questions may then be evaluated by presenting the experimental or developmental questions to sample populations under conditions of high-stakes exams taken by sample populations, and analyzing the question results, to develop a CAT exam. This process of developing a CAT exam may be costly due to the need to present the questions to sample populations and measure the parameters of the questions. CAT exams such as the GMAT may include questions that are experimental, or developmental. Experimental or developmental questions may be newly written or created questions, for which a difficulty has not been determined. Difficulty of a newly written or created question may be determined by presenting the question to populations of test-takers under the conditions of an actual high-stakes test, where the test-takers do not know whether the question is experimental or developmental; typically, in this scenario, the results of answering an experimental or developmental question do not count toward the test taker's score on the exam, but rather, the difficulty level of the experimental or developmental question itself is being measured. In addition to measuring the difficulty level of the question, the answer choices, which may include trap answers designed to trick a student with incomplete understanding or lower ability, may also be scored or evaluated for their effectiveness in determining the test-taker's ability levels. In a high-stakes exam with experimental or developmental questions, the student is not informed whether the question is experimental or developmental. Hence, the student will need to treat the question as a real question to be scored that has an impact on their score and the CAT's algorithm. In view of this, although experimental or developmental questions may not be graded, they may affect a student's score by forcing a student to spend time and effort in answering each experimental question. In addition, although a CAT algorithm will typically operate to converge on a test-taker's ability level, such that once the CAT algorithm's assessment of the ability level stabilizes, the test taker may expect questions close to their ability level, which may remain in a narrow range during a test. However, if experimental or developmental questions are presented during a test, the experimental or developmental questions may be selected at random with respect to difficulty level because the difficulty level of an experimental or developmental question is not known. In view of this, test takers may experience a sudden and significant change in the difficulty level of a question when an experimental or developmental question is presented during a test. When taking practice tests, it is therefore necessary to have a test designed to replicate this experimental functionality in order to accurately simulate the GMAT. However, some students might find this to be off-putting because they do not wish to take practice tests not customized to their skill level. Although the percentage of GMAT questions which are experimental or developmental is not known, estimates are as large as twenty-five percent, or higher. Thus, experimental questions are both a common feature of standardized tests, and present problems to test-taker's seeking to improve their score. Those of ordinary skill in the art will recognize that various IRT models, item parameters, and CAT algorithms, and CAT scenarios different from those described here may be used in a CAT system without departing from the teaching herein.

Preparing for CAT-driven assessment exams such as the GMAT presents multiple challenges to the test-taker desiring to master the test. Due to the high-stakes nature of the test, the material tested can be extremely challenging for questions near maximum difficulty level, and the more difficult questions typically require the most time. Failure to finish all questions may result in severe penalties in the form of score deductions, in addition to loss of points for the questions left uncompleted. In view of the strong incentive to achieve the maximum possible score on such tests as the GMAT, a test-taker's pace of answering questions during the test is crucial to finish the test, and maximize their score. For example, if the test-taker spends too much time on some questions in an effort to solve the more difficult problems presented to their skill level, there may be insufficient time to finish the test with enough time spent per question to have a reasonable chance of obtaining a correct answer. Recalling that tests such as the GMAT have the constraint that a test-taker cannot return to previous questions, if a test-taker spends too little time on questions presented earlier in the test in an effort to conserve time for more difficult questions, the test-taker may make mistakes due to being in a hurry, and unnecessarily lower their score. In view of this, proper pacing techniques are crucial to achieving the test-taker's best score on tests such as the GMAT. Completing a test at a pace that is too fast or too slow may be a pacing error, which the test-taker will need to identify and correct to improve their score.

Pacing systems and methods in the prior art may track the user's time per question, or track an overall time for an exam, and display the remaining time, the offset from the normal pace, or issue alerts when the test-taker falls behind a predetermined pace. However, these alerts frequently represent ‘false positives’ to a strong test-taker who may actually be ahead of pace overall, but simply took a little extra time on an extremely difficult question, while remaining on, or even ahead of, an adequate pace to finish with a good score; in such a case, the prior art systems and methods unnecessarily interrupt the test-taker's concentration, degrading their capacity to improve their knowledge and test taking skills. In view of this, there is a need in the art for test preparation systems and methods with improved pace tracking and analysis.

Further deficiencies of the prior art systems for GMAT test preparation relates to the prior art test preparation systems providing suggestions, hints, or additional information to the test-taker. Such systems frequently and unnecessarily interrupt the test-taker, and as in the case of false positives in the realm of pacing analysis.

Another problem with existing test preparation systems and methods relates to the existence and handling of non-scored experimental questions in tests such as the GMAT which have such questions. The experimental questions are of unknown difficulty before they are presented to many test-takers in the GMAT; after many test-takers have answered the experimental questions the difficulty of the questions are measured from the historical data, and eventually, the experimental questions may become real GMAT questions, which will be scored. Although prior art test preparation systems exist which attempt to replicate the GMAT or similar tests using experimental questions, the handling of experimental questions in the prior art systems do not optimize test preparation. Because the experimental questions are of all possible difficulties, and presented at random completely outside the control of the CAT algorithm, every test-taker will receive some experimental questions that are a significant distance in difficulty level from the test-taker's skill level. This is a particularly bad problem for expert test takers, who may only want difficult questions; if using a test preparation system that attempts to replicate the GMAT experience with respect to the handling of experimental questions in the real GMAT, an expert test-taker desiring questions only of a high difficulty level will be presented with some experimental questions far below their skill level, and a less-than-expert test-taker will be presented with some experimental questions far above their skill level. On the other hand, a student who wishes a true accurate representation of the standardized test will need these experimentals in his test and wishes to know which ones were experimentals. This can severely degrade the test preparation efficiency, depending on the percentage of experimental questions in a test preparation scenario; estimates of the percentage of experimental GMAT questions in the actual GMAT vary (the actual percentage of experimental questions is not disclosed by the test creators), up to twenty-five percent or more. Prior art systems that attempt to replicate the GMAT handling of experimental questions fail to provide an effective test preparation experience. The problems with the existing simulated tests include: 1) The existing simulated tests are excessively difficult because there are no “breaks” consisting of randomly generated easy experimental questions for high scoring students (and vice versa for low scoring students); 2) Since top students will ALWAYS get hard questions on accurate adaptive test engines, easy experimentals would generate confusion (and vice-versa for lower-scoring students receiving more difficult experimentals). For example, a low-scoring student may encounter a highly difficult experimental and get stuck on test day because their simulated exams did not include this scenario. In this situation, the Excessive Time error indication of the present invention is especially useful because it will prevent students from wasting time on experimental questions that are excessively hard. Although experimental questions do not count for scoring, they can waste excessive amounts of time. Top students will assume that the random “easy” experimental question that they encounter on test day is some form of bug. They need to practice with the “flawed” adaptive engine as they will encounter on test day. Thus, they need to make the conscious decision of choosing an “experimental” version; and 3) on the other hand, some students may not wish to have a “broken” CAT engine generating random experimental questions. They would prefer to take questions at their skill level. No existing GMAT product offers an “Experimental Mode” whereby the user may choose to have experimental questions or not with the concomitant changes to the IRT/CAT algorithm to reflect fewer questions. Some students may want experimentals for a “dress rehearsal” while others may want accurate practice. It is a gaping hole in the industry that this “Experimental Mode” function is not active.

Although prior art systems exist which provide suggestions during a test preparation scenario, analysis of test-taker errors in pacing and answering questions is not available to the test-taker after the test in a form most useful to review, understand, and learn from their errors. In view of this, there is a need in the art for test preparation systems and methods with improved test-taker diagnostic review modes that prevent false positives. Ultimately, students need behavior modification to change bad test strategy errors, and these alerts must be accurate, insightful and effective, lest they be ignored and lose the confidence of the test taker.

### SUMMARY OF THE INVENTION

The present invention relates to the field of test preparation. Specifically, embodiments of the present invention provide improved systems and methods for test preparation, including teaching the test-taker normal pacing techniques, improved pacing tracking and analysis, and providing tips and strategies for improving one's pace and performance on an exam. This is the first comprehensive technology to teach test-taking strategies for the new generation of tests using CAT algorithms that will dominate education.

Errors are benchmarked using a global “Pace Time” variable. This is calculated by simply dividing the time for the test by the total number of questions. So, a 50 question test with 100 minutes assumes 2 minutes per question as the global “Pace Time.”

However, if questions are unequal in time lengths, then this data will need to be adjusted. For example, if the first few questions of the test comprise reading lengthy passages, then a student could run behind. However, these variances generally average out. This means that the ideal “Pace Time” could stack the “median” value of students who finish the test on time for the first few questions, if necessary, to adjust the values so that the Pace Time is not noticeably off.

Once we have the Pace Time calculated, we can use it to tailor customized responses and bolster the validity of alerts. An assumption behind the present invention, based on student feedback, is that they do not like their tests interrupted without good reason. Indeed, the Virtual Tutor must be provided with an option to be disabled. The “false positives” which may include alerts delivered to a test taker who may not need them will be distracting and will also lead to students ignoring comments that are serious. However feedback can be enormously helpful in breaking bad habits if it is scrupulously tailored by cleverly leveraging numerous data points easily generated by educational software. By screening alerts through various data points, such as (1) student skill level, (2) question difficulty, (3) question number, (4) current pace time, (5) current time remaining, (6) historical statistical data on time completion of the question by skill level, (7) experimental status, changes in answer choice, (8) accuracy of student choice, (9) time spent on question and other available data, the algorithms screening these alerts can function as a form of artificial intelligence that can effectively analyze the student's performance for test strategy errors, without unnecessarily distracting or desensitizing test takers who may not benefit from all possible alerts, while providing more alerts to test takers who need them. When coupled with descriptive and interactive diagnostic graphs, the result is the means to both teach and describe the proper test strategies. The fundamental purpose of test prep is to teach test taking skill, and this technology achieves this objective by harnessing data points to construct accurate diagnostics and alerts. These errors include:

### 1) Too Much Time

This error is simply defined as spending an excessive amount of time on that specific question. “Too much time” could be calculated using numerous methods, such as by the question type, or statistical analysis of the distribution of times spent by students, students of the student's skill level, and editorial discretion. But, this error is more significant when the student is running short of time. Time is fungible across a test. So, for example, if the student is ahead of “Pace Time” and on pace to finish the test on time, then extra taking time to choose an answer is a rational decision and perhaps not a grievous error worthy of injecting a pop up. However, if a student is far behind “Pace Time” and they inexplicably spend an excessive amount of time on the question, then this would tilt the algorithm decisively to issuing an alert (sometimes a pop up or sometimes simply a red color of the time depending on the seriousness of the issue). Unlike the other alerts, which would best occur between questions to minimize distractions, this pop up should occur during the question (depending on the severity). The severity of the alert is a function of the extent of the following test taking taboos committed by the student on the given question. At lowest, the student would get text in the explanation box of the question notifying him of his minor breach. At worst, he will get interrupted mid question.

### 1a) Changing Answers

A subset of “Too much time” is a common error where the user spends too much time on a question, as defined above, but also changes their answer from the correct one to an incorrect one. In this case, the student's excessive time, far from doing good, actually results in an error. For this parameter, the pop up would be triggered after answering the question and with a reduced “too much time” allotment. For example, while (1) would require 10 minutes on a given question, (1a) would require 7 minutes because under some conditions Changing Answers correlates with incorrect choices. When the student appears to be haphazardly changing his choices, it would indicate the need for a real time alert.

### 1b) Getting it Wrong

Paradoxically, the questions that students spend the most time on are also often the questions that the student gets incorrect. If a student spends excessive amounts of time on a question AND gets it incorrect AND changes answer (to the wrong one from the correct one) AND is behind pace, then the student has committed a superfecta of test strategy errors that would likely warrant an immediate pop up alert. By using these discriminating factors, more serious errors may be called out, and hopefully prevented. If there are fewer major problems, such as spending a long time on a question, when ahead of pace, and getting it correct, then this likely would not trigger an alert unless the excessive time was extraordinary. At most, this event would likely just trigger a minor notation in the explanation pop up of the question at the end of the test that too much time was spent.

### 2) Hurried “Impulse Choices”

This is spending too little time on a question (and choosing the wrong answer). “Too little time” could be calculated using numerous methods, such as by the question type, or statistical analysis of the distribution of times spent by students, students of the student's skill level, and editorial discretion. But, this error is only real when the student is not short of time. So, for example, if the student is far behind “Pace Time” and on pace to not finish the test on time, then rapidly choosing an answer is a rational decision and perhaps not a grievous error worthy of injecting a pop up. However, if a student's time is comfortable and he inexplicably makes a careless impulse rapid decision, then this would tilt the algorithm decisively to issuing an alert. Further, it is common for high scoring students to rush through easy questions and make careless errors. This specific error warrants an alert on the assumption that taking a few seconds to double check could have likely prevented the mistake. Such caution is often required on even “easy” questions of standardized tests.

### 3) Behind Pace

This is an elementary calculation if the user is far behind the normal pace as calculated by the global Pace Time above. However, this may need to be adjusted by factors if the distribution of time-intensive questions is stacked in certain locations. This is a function of number of questions completed versus time remaining in the test.

### 3a) Last Minute Hurrying

Many tests require users to answer all the questions before time expires. This means that users will need to be alerted if behind the pacer to a stricter standard than (3).

### 4) Ahead of Pace

Some tests, like the GMAT, does not allow users to revisit prior questions. In this scenario, getting far ahead of Pace Time could be damaging. This is less of an issue if the user's score pattern is far above norm and the user's accuracy is high. It would be needless to alert a high-achieving student under these circumstances, so the highest few percentile students could have this error message eliminated altogether or restricted to a larger amount of minutes or time calculated. On tests where test-takers can revisit previous questions, it is less of an issue and being excessively ahead of pace is less of a problem (meaning that this alert can be disabled or set to a very high threshold). For some exceptional students, being “Ahead of Pace” is no flaw at all because they can breeze through questions. Given this, such alerts should be limited because the student does not need the extra time. By limiting alerts in such a careful manner, we can reserve the test-taker's attention for more serious matters, such as if the said high scoring student made careless errors on easy questions far below his skill level.

### 4a) Last Minute Excessive Time.

As above, if the user is nearly finished with the test and has excessive time, then they should be alerted. The parameters will be reduced if there are a few minutes left to make this pace time error more likely. It is common for students to ruin their test (and potentially their future career) with a single botched question: (1) taking too much time (2) behind pace (3) running out of time (4) changing answers (5) getting the question wrong. Yet, no software exists to carefully parse out such grievous errors.

### 5) Restrict Annoying Messages

To prevent annoying the test-taker, subsequent pop ups for the same errors would require higher thresholds or be curtailed altogether. This means that a student will not get an “Ahead of Pace” pop up after every question until the circumstance is rectified.

A secondary benefit of the discrimination alerts above is that the alerts can be stored and recalled in the user's explanations and diagnostic graphs. Less minor breaches of test prep strategy may be displayed in the explanations in lieu of annoying the student during the test. Explanations are therefore dynamic and can be personalized to the student's test strategy errors and/or weak topic areas (FIG. 13). This allows the user to recall the errors and re-learn from their mistake. The seriousness of the error may be quantified by how much they exceeded the parameters for the alert in the explanation text or reflected visually in the graphs. Certain minor errors might be flagged in the explanation text that were not mentioned in real-time during the test (a lower alert threshold). The preferred embodiment (FIG. 12) shows the entire test so that the student can see exactly how his pacing was conducted, and this may also include a zoom on the critical final few minutes. In an embodiment of this invention, the user may be presented with an interactive visual representation of the pacing analysis, enabling the user to click the exact question where he made the excessive time errors to pinpoint exactly where they ruined their pacing.

A further feature of the present invention that dovetails with the Virtual Tutor is Dot Diagnostics. Since the early 1980s, test preparation and learning explanation pages have consisted of rows of results. Clicking a question number would bring up the explanation for the question. Further, bar graphs would be used to identify strengths and weaknesses. The new “dot” diagnostics of the present invention blurs the line between a “diagnostic” and an “explanation page” because each of the dots is clickable to open up the explanation for the specific question. This is a design functionality whereby traditional bar graphs are replaced with rows of interactive dots. This creates an intuitive and elegant system where each question is represented by a dot across several diagnostic graphs. It allows the numerous Virtual Tutor alerts to be visualized and clicked for more information. Dots (or the background underneath them) might reflect different question types. For example, reading comprehension questions might be represented by a different background shade color since they occur in a row and consume much time. Since there will be several diagnostic pages, the dots change color subtly after they are clicked to prevent the user from clicking the same questions repeatedly. Current designs are deeply flawed because they show power point-style graphs, but as the Graduate Management Admissions Council has complained, students don't even understand the labels of charts. For example, if a student scored 0 of 5 on Polygons, then this data has limited value since the student may not even know what a polygon is. Further, the student cannot even click the graph to know what “polygon” questions he got wrong. The student will need to read through explanation pages to see his “weakness” areas. The preferred embodiment allows users to have diagnostics by these dots that change color to a grey shade after being clicked. This is similar to Youtube, wherein the video thumbnails change color after being clicked (they turn a shade of grey so that users don't click a video that they watched before a second time). Using Dot Diagnostics, the user can click open the question where the student got the answer incorrect. Further, the dot graphs may include results from prior test since results from a single test may not be sufficient to establish poor performance. This functionality need not apply only for tests, but any result page for testing.

A further feature of the present invention useful for test preparation is Integration of Experimental Questions. Major standardized tests commonly have experimental questions integrated into the tests. “Experimental” questions are being vetted for quality and difficulty. Adaptive test algorithms require that each question have a specific difficulty level so that it can be delivered to students of certain skill levels. Experimental questions do not count for scoring and are a distraction to the testing process. From the student perspective, when taking adaptive tests these questions stand out because they are not adaptive. High scoring students, for example, may encounter low-level experimental questions randomly, and low scoring students may encounter high-level experimental questions randomly. This makes the actual test day experience entirely different from their practice exams (which in the prior art systems studiously attempt to methodically replicate an adaptive algorithm and produce similar questions). The problem is that students expect a 100% accurate adaptive test (and don't want “easy” questions if they are high scorers), yet this also means that the practice adaptive tests are not realistic simulations because the simulated tests are excessively accurate. The result is an excessively hard simulated test that requires more endurance because the difficulty level is consistently hard. Indeed, students commonly complain on forums about adaptive tests that contain easy questions, even when the real test will likely do the same. So, a ninety-ninth percentile student, when taking a commercially available test, may get 20 ninety-ninth percentile questions in a row. However, this would never happen on a real test, where several experimentals of twentieth, forty-seventh, and sixty-seventh percentile difficulty may be thrown in the mix. Thus, there is a chasm between hyper-accurate simulated tests and the real test loaded with random experimentals. Top students will assume that the random “easy” experimental question that they encounter on test day is an error. They need to practice with the “flawed” adaptive engine as they will encounter on test day. Thus, they need to make the conscious decision of choosing an “experimental” version. Problems with the existing simulated tests include (1) Tests are excessively difficult because there are no “breaks” for high scoring students (and vice versa for low scoring students); (2) Since top students will ALWAYS get hard questions on accurate adaptive test engines, easy experimentals would generate confusion (and vice-versa). For example, a low-scoring student may encounter a highly difficult experimental and get stuck on test day because there simulated exams did not include this scenario. In this situation, the Excessive Time error as listed above is especially useful because it will prevent students from wasting time on experimental questions that are excessively hard. Although experimental questions do not count for scoring, they can waste excessive amounts of time; top students will assume that the random “easy” experimental question that they encounter on test day is a mistake. They need to practice with the “flawed” adaptive engine as they will encounter on test day. Thus, they need to make the conscious decision of choosing an “experimental” version; (3) The tests do not teach the functionality of experimental tests or give the experience of taking the test accurately; (4) Even if the simulated adaptive does include experimental questions, if they are not flagged the experimentals will merely confuse the student and act as errant data in the scoring and diagnostics. A further feature of the present invention useful for test preparation is about using an Experimental Mode. Test preparation for adaptive test like the GMAT and GRE exams, among others, are grievously flawed in that they do not allow student to have an optional “Experimental Mode.” Thereby, students would be able to choose a mode where the simulated computer-adaptive test is made “worse” to more accurately simulate the flawed official tests (where experimentals are randomly injected) and the student will know that this “worse” test is functional and not a result of a buggy adaptive engine. In the conclusion of the test, these experimentals would not count to the user's score and would be flagged as experimentals. If a student wishes to take the test in “Standard” mode, he would simply get a series of adaptive questions. Experimental questions need to be “normed” by scaling the score calculation and adaptive algorithm to weigh adaptive questions less (since there are more of them) and thereby establish functional and scoring similarity, despite differences in numbers of counted questions, and require their own database of data to establish this norming.

A further feature of the present invention useful for test preparation is Experimental Question Diagnostics. Even if the simulated adaptive does include experimental questions, if they are not flagged, the experimentals will merely confuse the student and act as errant data in the scoring and diagnostics making it difficult to compare the scores across test-prep scenarios in different modes of handling experimental questions. In the preferred embodiment, the experimentals are parsed out in diagnostics (usually represented by a beaker).

A further feature of the present invention useful for test preparation is Light Adjustability. Users can adjust the background image to make the test easier to use depending on their lighting conditions. This could be controlled as default by the device itself if it can sense ambient light conditions. Screen brightness becomes a major factor when staring at a screen intensely for hours. This is based on jet-fighter “night modes” where dash lights are disabled. The “skins” reflect their favorite school cast in either dark or light colors. These skins could be opened up by certain scores.

### BRIEF DESCRIPTION OF DRAWINGS

FIG. 1 illustrates a schematic overview of a computing device, in accordance with an embodiment of the present invention.

FIG. 2 illustrates a network schematic of a system, in accordance with an embodiment of the present invention.

FIG. 3 illustrates a flow diagram for a method for test preparation, in accordance with an embodiment of the present invention.

FIG. 4 is a screen shot of a web page showing a pacing indication displayed by an embodiment of the present invention.

FIG. 5 illustrates a flow diagram for a method of custom intervention, in accordance with an embodiment of the present invention.

FIG. 6 illustrates a flow diagram for a method of pacing analysis and tracking, in accordance with an embodiment of the present invention.

FIG. 7 illustrates a method for Normal Time calculation in pacing analysis and tracking, showing how normal question pace time and normal question pace time ranges are calculated in accordance with some embodiment of the present invention.

FIG. 8 illustrates alternative methods for Normal Time calculation in pacing analysis and tracking, showing how normal question pace time and normal question pace time ranges are calculated in accordance with some embodiment of the present invention.

FIG. 9 illustrates a Test Preparation System, in accordance with an embodiment of the present invention.

FIG. 10 illustrates a question database record, in accordance with an embodiment of the present invention.

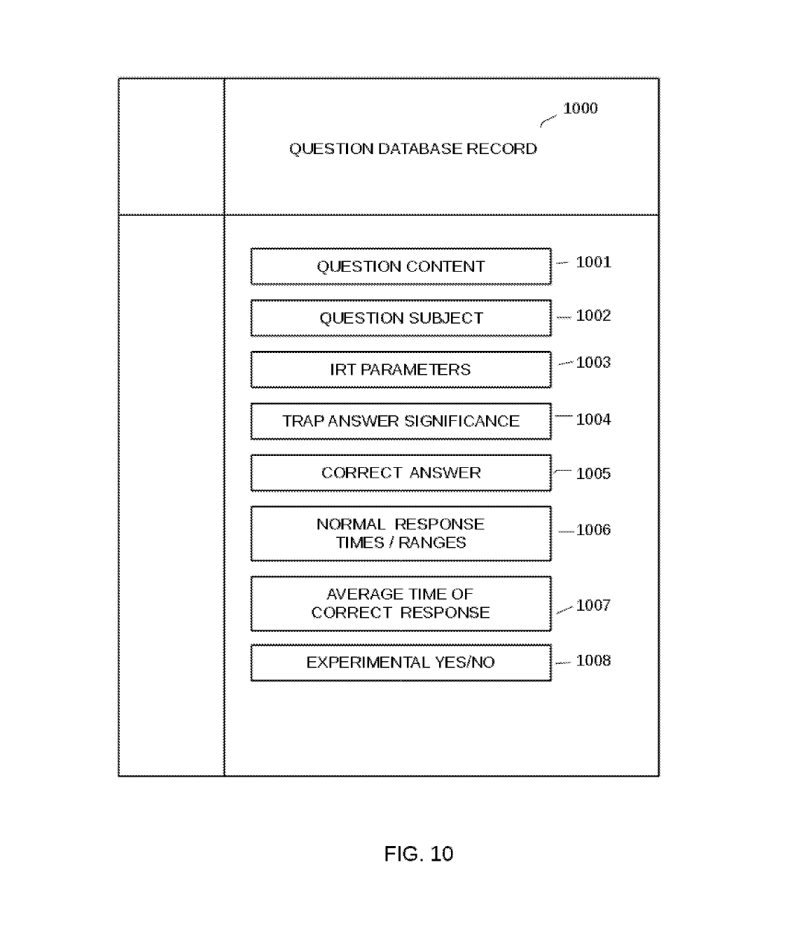

FIG. 11 is a screen shot of a web page showing a pacing indication displayed by an embodiment of the present invention.

FIG. 12 is a screen shot of a web page showing pacing analysis and pacing dot diagnostics displayed by an embodiment of the present invention.

FIG. 13 is a screen shot of a web page showing question dot diagnostics displayed by an embodiment of the present invention.

FIG. 14 is a screen shot of a web page showing experimental question dot diagnostics displayed by an embodiment of the present invention.

FIG. 15 is a screen shot of a web page showing adaptive dot analysis displayed by an embodiment of the present invention.

FIG. 16 illustrates an optional process flow for an experimental mode and adaptive mode for an adaptive test, in accordance with an embodiment of the present invention.

FIG. 17 illustrates a flow diagram for methods of creating diagnostic pages, in accordance with an embodiment of the present invention.

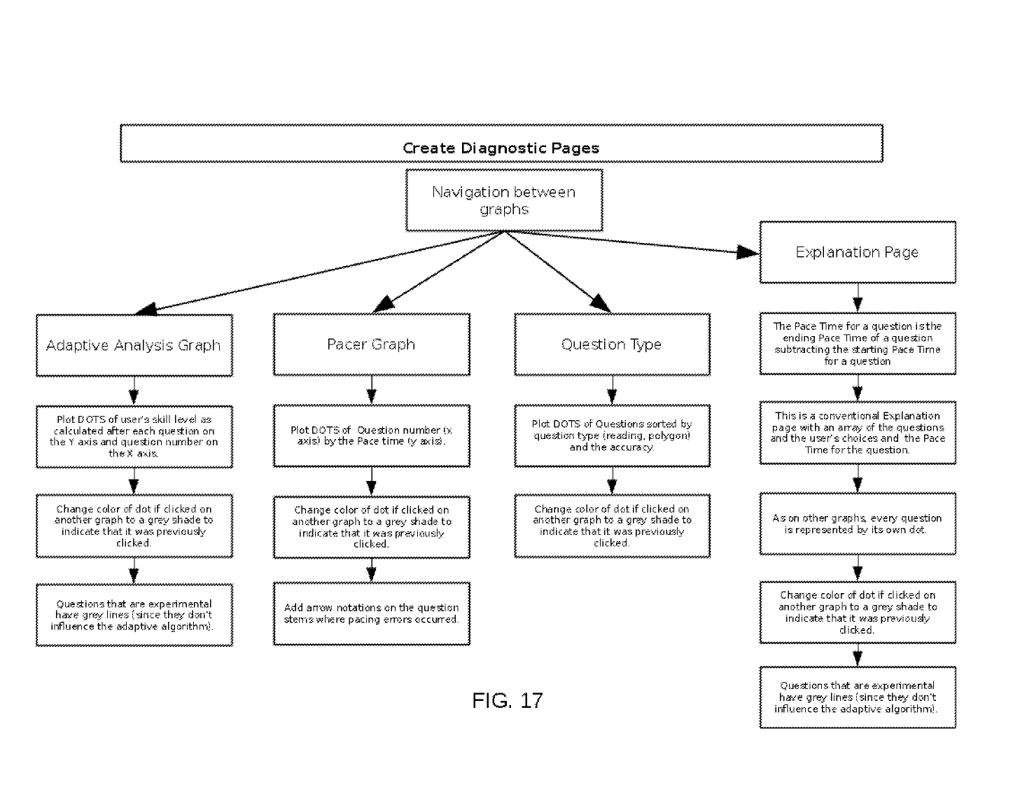

FIG. 18 illustrates a flow diagram for methods of providing question dot diagnostics pages.

### DETAILED DESCRIPTION OF INVENTION

The present invention generally relates to exam question tutoring and pace setting. The invention provides a digital pace indicator that informs a test-taker of how their pace compares to a normal pace. In addition, the invention provides feedback to help a user improve their pace when answering questions.

The terms “user”, “test taker” and “student” shall be regarded as equivalent terms throughout this application.

Certain features described in the context of various embodiments are not to be considered essential features of those embodiments, unless the embodiment is inoperative without those elements.

The invention can be implemented in numerous ways, including as a process; an apparatus; a system; a composition of matter; a computer program product embodied on a computer readable storage medium; and/or a processor, such as a processor configured to execute instructions stored on and/or provided by one or more memories coupled to one or more processors, where such memories and/or processors may reside on one or more host computers or servers and may be connected by one or more networks or busses. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured or otherwise permanently configured to perform the task.

A detailed description of one or more embodiments of the invention is provided herein along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the description herein in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Throughout this application, various features, capabilities, characteristics, qualities, or other properties, of various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range. Whenever a numerical range is indicated herein, it is meant to include any cited numeral (fractional or integral) within the indicated range, unless otherwise explicitly limited to integral values. The phrases “ranging/ranges between” a first indicated number and a second indicated number and “ranging/ranges from” a first indicated number “to” a second indicated number are used herein interchangeably and are meant to include the first and second indicated numbers and all the fractional and integral numerals there between.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor.

Benefits, features, and advantages of the present invention, in addition to the structure and arrangement of various embodiments of the present invention, are described in detail herein, with reference to the accompanying drawings. Note that the embodiments of the invention disclosed herein are illustrative and explanatory of the invention, and do not limit the invention to those specific embodiments disclosed. Those with ordinary skill in the relevant art(s) will recognize additional embodiments of the invention beyond those disclosed herein, in view of what is commonly known in the art(s) and the teaching herein.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

It is expected that during the life of a patent maturing from this application many relevant new technologies in various related fields will be developed and the scope of the related terms used herein are intended to include all such new technologies a priori.

As used herein, the singular form “a”, “an” and “the” include plural references unless the context clearly dictates otherwise. For example, the term “a compound” or “at least one compound” may include a plurality of compounds, including mixtures thereof.

As used herein the term “about” refers to plus or minus ten percent, unless otherwise indicated, in addition to the plain meaning of the common definition(s) of the term.

The terms “comprises”, “comprising”, “includes”, “including”, “having” and their conjugates mean “including but not limited to”. This term encompasses the terms “consisting of” and “consisting essentially of”.

The term “computing device” is used herein to mean any electronic, biological, quantum, or other device with a processor and means for data storage.

The phrase “consisting essentially of” means that the composition or method may include additional ingredients and/or steps, but only if the additional ingredients and/or steps do not materially alter the basic and novel characteristics of the claimed invention, or render the claimed invention or embodiment thereof inoperative.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The term “hardware resource” is used herein to mean a computing device optionally with one or more network connections, in addition to the plain meaning of the common definition(s) of the term.

The word “optionally” is used herein to mean “is provided in some embodiments and not provided in other embodiments”. Any particular embodiment of the invention may include a plurality of “optional” features unless such features conflict or render the invention inoperative.

The word “content” is used herein to mean text, graphics, video, audio, simulated input including simulation of pointing device clicks, text input, scrolling, and other input, output, alerts, hints, suggestions, prompts, pointers, arrows, comments, timed content, delayed content, modified content, synchronized content, in addition to the plain meaning of the common definition(s) of the term.

The words “deliver”, “delivery”, and “delivered” are used herein to mean the functions of an application user interface such as in a web browser or other visible, auditory, tactile, or electromagnetic interface, including conveying information to a user and accepting information from a user, in addition to the plain meaning of the common definition(s) of the term.

The phrase “dynamic content” is used herein to mean any kind of content, including customized interventions or alerts as described herein, that may be added to, injected into, modified on, removed from, or, if unmodified from the original after a decision by an algorithm described herein, allowed to remain, in an application user interface such as a web page.

The word “interactive” is used herein to mean responsive to events and actions, within or external to an application user interface, including user actions, application actions and events, and other actions and events, in addition to the plain meaning of the common definition(s) of the term.

Used herein, the term, “maintaining” refers to keeping a resource functioning, in addition to the plain meaning of the common definition(s) of the term.

The terms “network” or “network connection” are used herein to mean one or more communication paths with or without associated or connected devices such as firewalls, routers, bridges, switches, intrusion detection systems, concentrators, or other network devices commonly known in the art, which allow a plurality of computing devices to communicate.

The term “network packet” is used herein to mean a formatted message transmitted over a network.

The term ‘processor’ is used herein to mean one or more devices, which may be of physical, virtual, electronic, biological, quantum, or other types, comprising circuits, and/or processing cores configured to process data, such as computer program instructions.

The word “render” is used herein to mean the action, effect, or function of a web browser or other similar application or library to graphically and visually organize, manage, and present for display to a user or for capture as an image, a web page and the content included in the web page, in addition to the plain meaning of the common definition(s) of the term. The words ‘dot’ or ‘dots’ are used herein to mean: a graphically displayable shape which may have the form of: a circular dot; a square; a triangle; or any geometric shape; and may be visible or invisible, and of any size or any color; and may be clickable for user interactivity, or not clickable for user interactivity, in addition to the plain meaning of the common definition of the terms.

The word “server” is used herein to mean a computing device configured to provide computing, network, memory, storage, data, and other services or resources local to the host or remote from the host, including application servers, mail servers, proxy servers, storage servers, name servers, network servers such as but not limited to web servers, web application servers, virtual private network servers, streaming media servers, authentication servers, proxy servers, and other types and kinds of servers.

The term “virtual”, in addition to the plain meaning of the common definition(s) of the term, refers to an entity which internally does not have a physical representation corresponding to the features, function, or mode of operation, of the entity which it externally appears to be, or operates as, to or in interaction with other entities. Examples of virtual entities are processors, servers, and other resources; in the case of a virtual processor, one physical processor may be capable of being configured to emulate, or appear to operate, as if more than a single processor were available, or, may be capable of being configured to emulate, or appear to operate, as a processor of a type different from the internal physical representation of the entity configured to provide a virtual representation.

The term “virtual resource” refers to an allocation on a networkable computing device which refers to a virtual representation of a computing device or a software application, such as a database. Although the present invention has been described above in terms of specific embodiments, it is anticipated that alterations and modifications to this invention will no doubt become apparent to those skilled in the art and may be practiced within the scope and equivalents of any appended claims. More than one computer may be used, such as by using multiple computers in a parallel or load-sharing arrangement or distributing tasks across multiple computers such that, as a whole, they perform the functions of the components identified herein; i.e. they take the place of a single computer. Various functions described above may be performed by a single process or groups of processes, on a single computer or distributed over several computers in any topology or architecture known to one of ordinary skill in the art, including but not limited to standalone host computers, client-server architectures, distributed architectures using a plurality of networks, a plurality of host computers communicating via said plurality of networks, cloud architectures, cluster architectures, and the like. Processes may invoke other processes to handle certain tasks. A single storage device may be used, or several may be used to take the place of a single storage device.

The terms “communication”, “communications”, “communicating”, “communicated”, and common variations thereof, in addition to the plain meaning of the common definition of the terms, refer to bidirectional information transfer, where said information may include: network packets; interprocess communication, whether in a single memory space on a single host computer, or across one or more networks between multiple host computers; function or method calls, optionally including return values, in a computer program environment. In addition, said bidirectional information transfer may be optionally accompanied with processing of the transferred information, which processing may include the operation of protocols and semantic determinations supported by textual or binary syntactic parsing, information extraction, tokenization, storing parameters extracted from communicated information, forwarding received parameters to another module or modules, zero or more module state transitions, response generation and transmission, error handling, or other operations known to one of ordinary skill in the art as representative of communication, coordination, or collaboration among and between systems, hosts, modules, or subsystems, optionally according to one or more communication protocols.

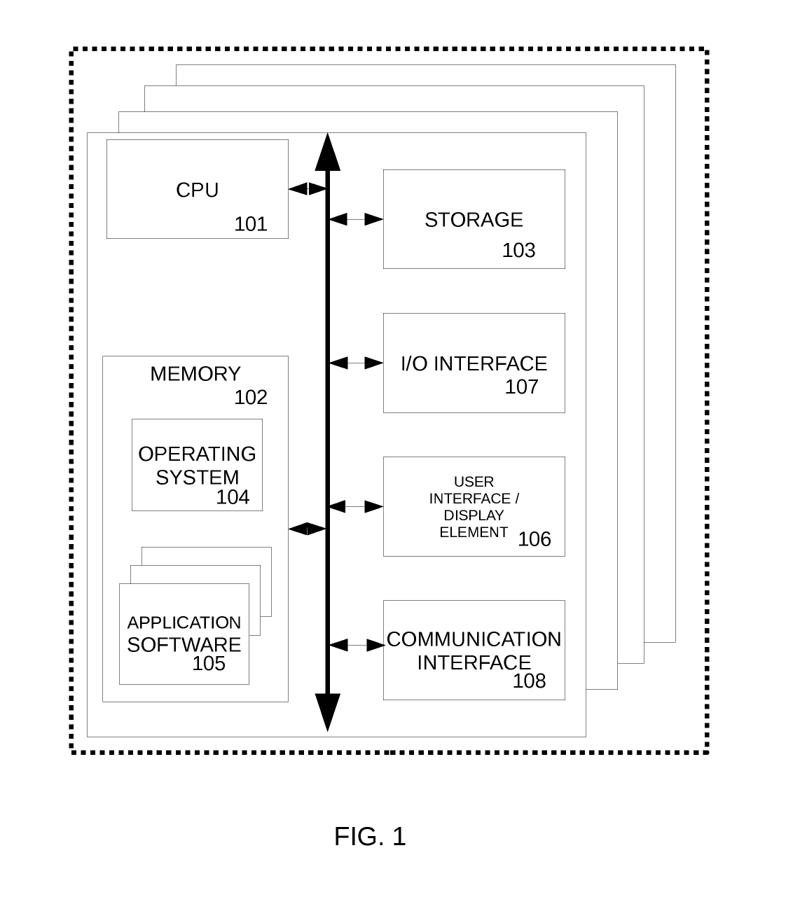

According to an embodiment of the present invention, the system and method is accomplished through the use of one or more computing devices. As shown in FIG. 1, One of ordinary skill in the art would appreciate that a computing device appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, one or more user interfaces/display elements 106, one or more input/output interfaces 107, and one or more communication interfaces 108. Examples of computing devices usable with embodiments of the present invention include, but are not limited to, personal computers, smartphones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to the users of the system across local area networks (LANs) (e.g., office networks, home networks) or wide area networks (WANs) (e.g., the Internet). In accordance with embodiments of the present invention, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network. However a user may be able to compose data offline that will be consumed by the system when the user is later connected to a network.

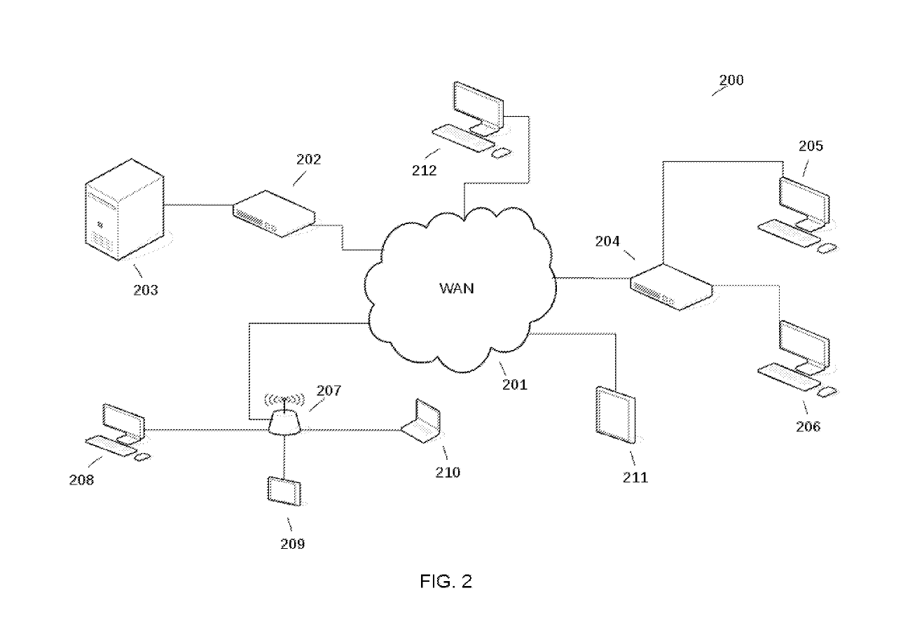

Referring to FIG. 2, a network schematic overview of a system 200 in accordance with an embodiment of the present invention is shown. The system 200 is comprised of one or more application servers 203 for electronically storing information used by the system. Applications in the application server 203 is configured to retrieve and manipulate information stored in storage devices and exchange information through a Network 201 (e.g., the Internet, a LAN, WiFi, Bluetooth, etc.). Applications in server 203 can also be configured to use manipulated information stored remotely and process and analyze data stored remotely across a Network 201 (e.g., the Internet, a LAN, WiFi, Bluetooth, etc.).

According to an exemplary embodiment, as shown in FIG. 2, exchange of information through the Network 201 may occur through one or more high speed connections. In some cases, high speed connections may be over-the-air (OTA), passed through networked systems, directly connected to one or more Networks 201 or directed through one or more routers 202. Router(s) 202 are completely optional and other embodiments in accordance with the present invention may or may not utilize one or more routers 202. One of ordinary skill in the art would appreciate that there are numerous ways a server 203 may connect to the Network 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via Network 201 or other networks in numerous ways. For instance, a component may connect to the system i) through a computing device 212 directly connected to the Network 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the Network 201. One of ordinary skill in the art would appreciate that there are numerous ways that a component may connect to server 203 via Network 201, and embodiments of the present invention are contemplated for use with any method for connecting to server 203 via Network 201. Furthermore, server 203 could be comprised of a personal computing device, such as a smartphone, acting as a host for other computing devices to connect to.

The present invention generally relates to a method and system for providing a pace indicator or “pacer” for answering exam questions along with relevant feedback in the form of tips and strategies for improving one's pace. In particular, embodiments of the present invention are configured to provide a user with a pace indicator to assist a user in gauging their pace as they answer test questions while also providing feedback for improving their pace based on the particular types of questions encountered. Feedback may be dynamically customized for a test-taker, generated and presented to a test-taker in real time during a test-prep scenario by the algorithms of the present invention, in addition to preprogrammed feedback presented to a test taker. Feedback, whether customized feedback for a test taker and presented in real time, or preprogrammed feedback, may be dynamic and interactive, as needed to provide the most effective test preparation experience for a given user.

In a preferred embodiment of the present invention, the system is comprised of one or more servers configured to manage the transmission and receipt of content and data between users and recipients. The users and recipients may be able to communicate with the components of the system via one or more mobile computing devices or other computing device connected to the system via a communication method supplied by a communication means (e.g., Bluetooth, WIFI, CDMA, GSM, LTE, HSPA+). The computing devices of the users and recipients may be further comprised of an application or other software code configured to direct the computing device to take actions that assist in test preparation.

According to an embodiment of the present invention, the system is configured to provide a pace indicator for answering test questions and provides feedback for improving the pace at which questions are answered. The system includes a database of test questions along with associated response times for answering the questions correctly. The questions and associated response times are further classified according to the level of proficiency of the test taker responding to the question. A range of normal response time is then determined for each question, which may be based, at least in part, based on one or more of the following factors: the type of question; level of difficulty of the question; subject matter of the question; time limit for completing the test; the average amount of time taken to answer each question correctly; and the variance and standard deviation from said average amount of time. One of ordinary skill in the art will recognize there are numerous parameters which could be used to classify questions and determine response times according to the techniques and methods known in the art. One of ordinary skill in the art will recognize that there are numerous ways to calculate a normal time range for correctly answering a question. Furthermore, the system of the present invention may employ a normal answer time range for each question, as opposed to a single normal time.

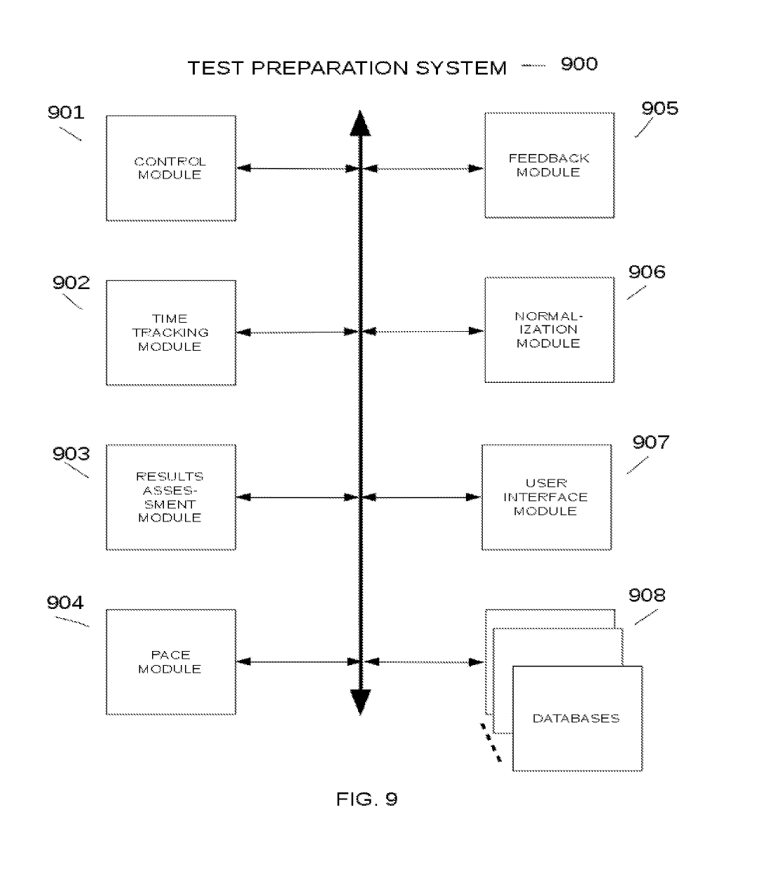

Referring to FIG. 9, an embodiment test preparation system 900 of the present invention includes one or more databases 908, a control module 901, a time tracking module 902, a results assessment module 903, a pace module 904, a feedback module 905, a normalization module 906, and a user interface module 907. In certain embodiments of the present invention, test preparation system 900 includes said modules 901, 902, 903, 904, 905, 906, and 907, and said one or more databases 908 interconnected by communicative coupling with all other said modules and said one or more databases 908. In particular embodiments of the present invention said communicative coupling may include software, hardware, or both, optionally in addition to networks. In some embodiments of the present invention said modules 901, 902, 903, 904, 905, 906, and 907, and said one or more databases 908 may reside in a single host computer or may be distributed across multiple host computers interconnected by one or more networks.

One or more databases 908 are configured with machine executable instructions to include the following functionality:
Storing database records including question database records 1000, accuracy data 1005, response times for answering each question every time the question was presented 1006, average response time calculated over all test takers for answering each question correctly 1007, test-taker profile and skill level data, historical test taker population performance data, historical test taker individual performance data, test taker response data, test configuration data, CAT algorithm definitions, IRT parameters 1003, experimental question data 1008, and results of scoring or accuracy checking test taker response data
Providing database records to other modules in response to one or more queries from one or more modules
Storing database records as directed by other modules
Communicating with other modules

### Accessing and Using Configuration Data

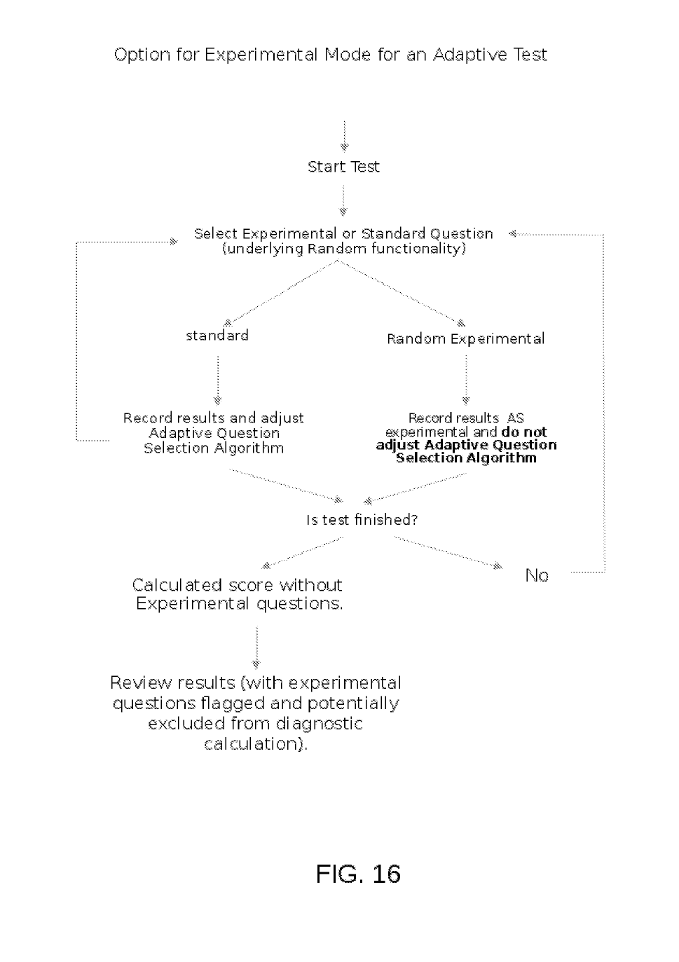

The control module 901 is configured with machine executable instructions to include the following functionality:
Querying a database 908 to obtain database records
Selecting one or more questions 1000 at random from a database 908
Obtaining student or test taker profile data including contact data from a database 908
Receiving configuration and determining the percentage of test questions that will be experimental questions
Having one or more CAT algorithms and associated parameters including: IRT parameters, control variables, and status variables
Receiving configuration and determining one or more test modes for execution by test preparation system 900 in accordance with certain embodiments of the present invention, wherein one or more test modes includes: experimental mode or adaptive mode as shown in FIG. 16; standard mode; test development mode; mock test mode; or, other modes such as would be known to those skilled in the art
Adapting the question selection procedure to select one or more experimental questions at random or by question IRT parameters 1003 or other question parameters, according to configuration
Selecting one or more questions 1000 with specified question parameters, including IRT parameters 1003 said parameters including a question difficulty level or test taker skill level, from a database 908
Sending a question 1000 or other information to the user interface module 907 for presentation to a test taker
Receiving the test taker's response data from the user interface module 907
Comparing the test taker's response data with the accuracy data from a database 908; accuracy data may include correct answer choices, trap answer significance, or other question database record 1000 data.
Storing in a database 908 one or more results for determining the accuracy of a test taker's response
Measuring the test taker's skill level in real time during a test, or offline with replayed data or data at rest, using one or more CAT algorithms, question IRT parameters including the difficulty level of the previous and current questions, accuracy data including whether the test taker correctly answered the last question, measured test taker response times, calculated normal times or normal time ranges, or configuration data.
Setting the test taker's skill level as configured (for example for the initial question in a CAT scenario wherein an estimate of the test taker's skill level may not be known before the first question with a known difficulty level is answered by the test taker and scored by the system in a CAT scenario).
Adapting, as configured, the test-taker's measured skill level, selected question IRT parameters, or CAT algorithm parameters, to adjust the rate at which a CAT algorithm adapts to a test taker's skill level.
Configuring the feedback module 905 with normal times or normal time range 1006 for a question 1000.
Notifying the feedback module 905 when a question 1000 has been presented to a test taker.
Notifying the feedback module 905 when a test taker has submitted a response to a question 1000.
Notifying the feedback module 905 when a test taker has changed the answer to a question 1000.
Notifying the feedback module 905 when a test taker has changed an intervention or alert preference.
Configuring the normalization module 906 to determine a normal time or range of normal times 1006 for answering each question 1000 in a database 908, and store the determined normal times or normal time range 1006 in a database 908.
Configuring alert and feedback thresholds in the pace module 904 and feedback module 905.
Notifying the feedback module 905 of the accuracy of a test taker's answer.
Accessing database 908 records.
Communicating with other modules.

### Accessing and Using Configuration Data.

The time tracking module 902 is configured with machine executable instructions to include the following functionality:
Having one or more timers
Resetting an individual timer to zero
Starting an individual timer
Stopping an individual timer
Providing the current reading of an individual timer
Setting an individual timer to a value greater or less than zero
Associating one or more timers with one or more modules, such that more than one module may be notified of timer expiration.
Reporting timer expiration to the modules using the timer.
Accessing database 908 records
Communicating with other modules

### Accessing and Using Configuration Data

The results assessment module 903 is configured with machine executable instructions to include the following functionality:
Obtaining student or test taker profile data including contact data from a database 908.
Polling students by contacting them to check if the test problems persisted after test day. Or, since the student may take several tests, checking if the problems persisted or were reduced through being described in the test results, charts, explanations, and/or alerts.
Receiving and storing student responses to polling in a database 908.
Obtaining calculated normal pace times or normal pace time ranges 1006 from the normalization module 906 or a database 908.
Obtaining measured normal pace times or normal pace time ranges 1006 from a database 908.
Comparing the measured time values with the calculated time values.
Analyzing the results of comparing the measured time values with the calculated time values, to determine if the calculated values are within configured tolerance.
Accessing database 908 records.
Communicating with other modules.

### Accessing and Using Configuration Data.

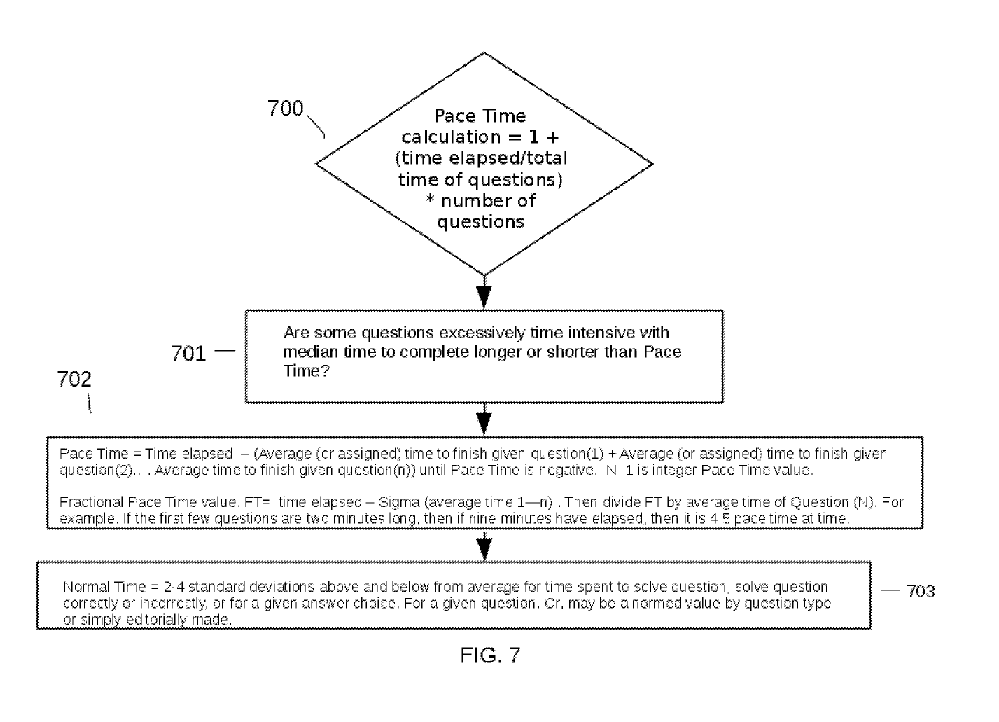

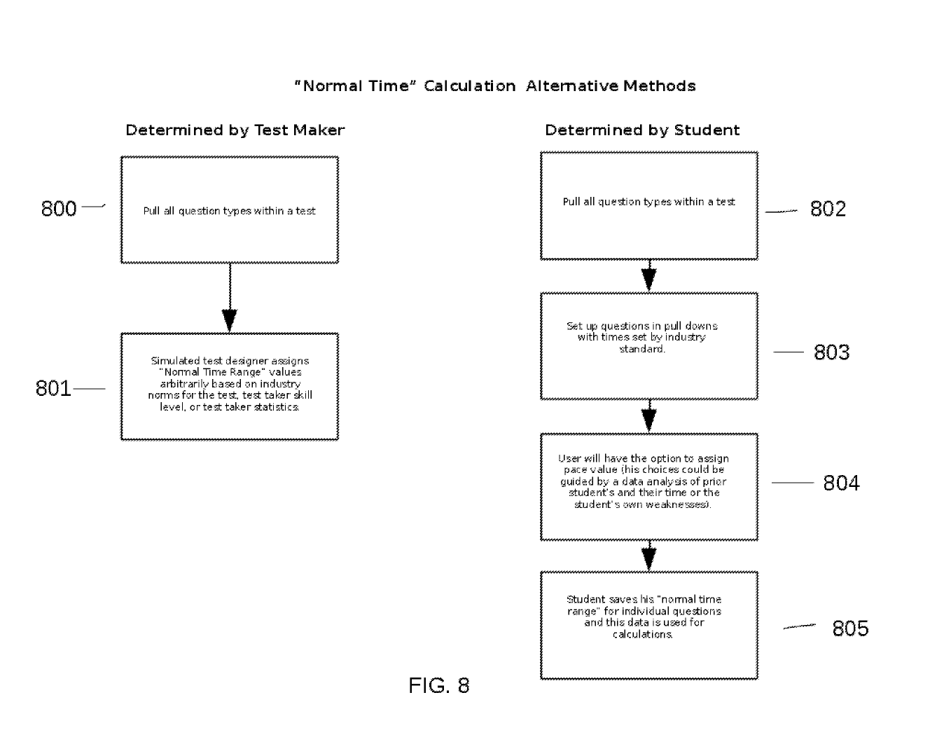

The pace module 904 is configured with machine executable instructions to include the following functionality:
Resetting a timer in the time tracking module 902
Starting a timer in the time tracking module 902, to begin measuring the test taker's response time.
Receiving configuration from feedback module 905 for the normal time or normal time ranges for answering the question or questions
Accepting configuration of alert thresholds limiting each alert type
Stopping a timer in the time tracking module 902, and obtaining the measured response time of the test taker
Calculating the current pace time and normal time which may in some embodiments be calculated according to FIG. 7 or FIG. 8
Provide via user interface module 907 and display element 106 a pace indicator which compares the amount of time spent by the user on one or more questions to the normal pace for answering the one or more questions
Reporting to the feedback module 905 when a test taker exceeds a pace time alert threshold
Reporting the test taker's pace to the feedback module 905 when test taker's measured response time is determined, and at other times while the test taker is answering a question
Accessing database 908 records
Communicating with other modules

### Accessing and Using Configuration Data

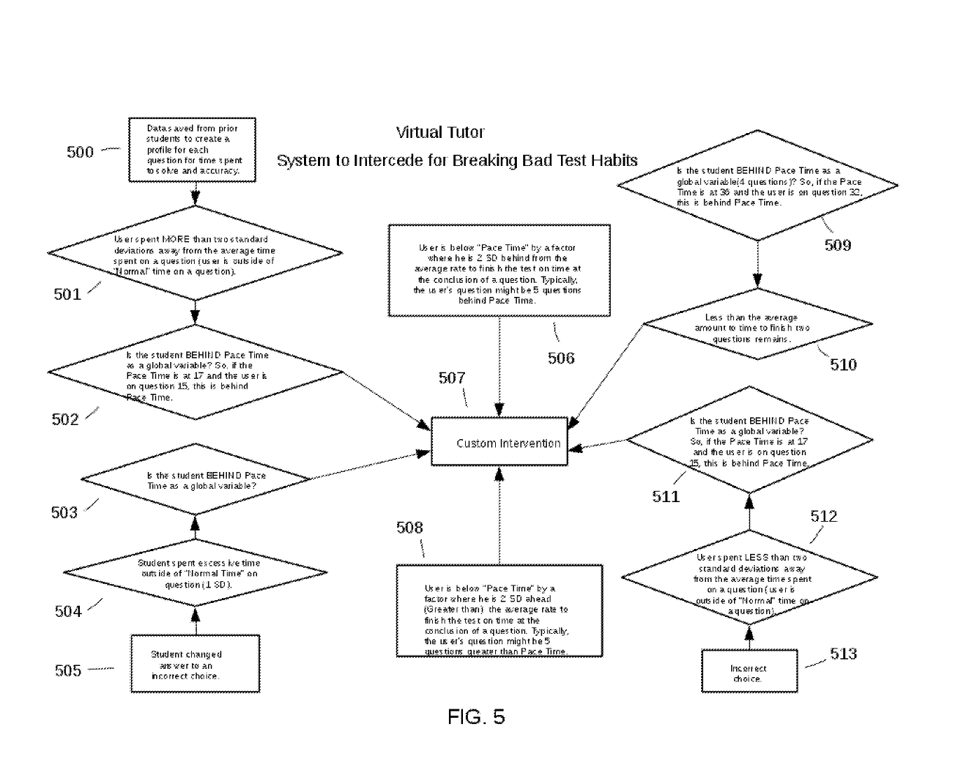

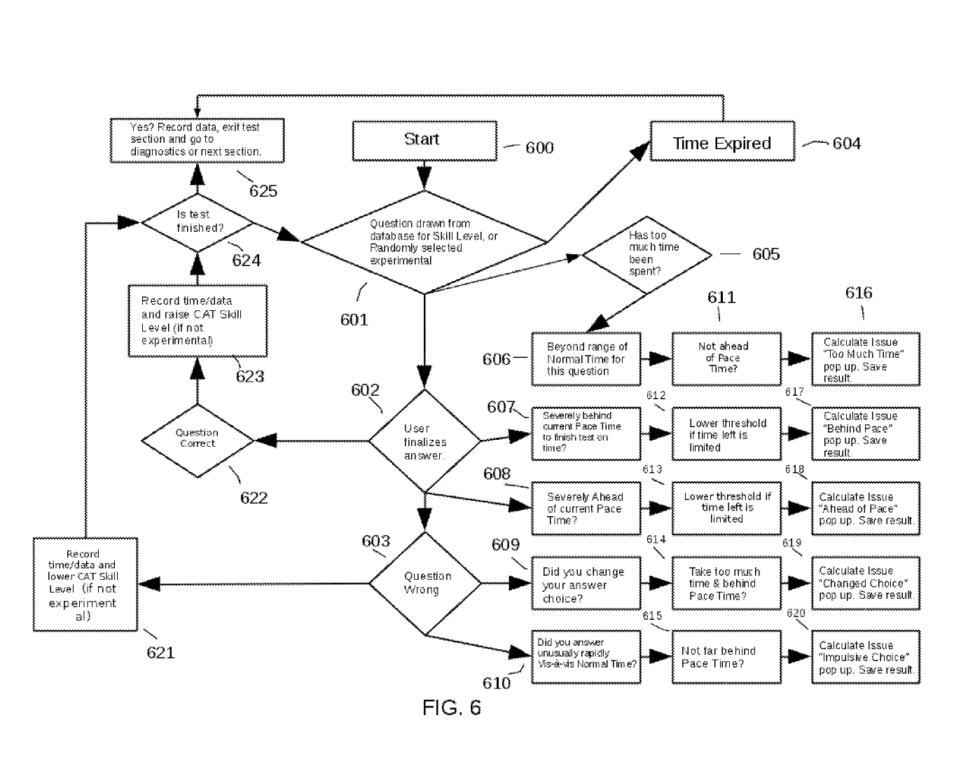

The feedback module 905 is configured with machine executable instructions to include the following functionality:
Providing a user with feedback for improving their pace of answering questions.
Receiving configuration from the control module 901 with the question record or records 1000 the test taker is answering.
Receiving configuration from control module 901 with normal times or normal time ranges 1006 for a question.
Receiving notification from control module 901 when a question 1000 has been presented to a test taker.
Receiving notification from a control module 901 when a test taker has submitted a response to a question.
Receiving notification from a control module 901 when a test taker has changed their answer to a question.
Receiving notification from a control module 901 when a test taker has changed an intervention or alert preference.
Configuring the pace module 904 with the question record or records the test taker is answering.
Configuring the pace module 904 with the normal time or normal time ranges for answering the question or questions.
Configuring the pace module 904 to begin tracking the test taker's pace in answering the question or questions.
Configuring the pace module 904 to stop tracking the test taker's pace in answering the question or questions.
Monitoring the time elapsed while a test taker is answering a question, and at configurable regular intervals while a test taker is answering a question deciding in real time whether to: issue interventions or alerts based on time elapsed, alert thresholds, alert history, intervention history, normal times or normal time ranges for answering a question, pace time per question, pace time remaining, global pace time, measured test taker response time, and test taker activity such as test taker changing answer choices.
Receiving the test taker's pace time from the pace module 904.
Receiving notification from the pace module 904 when a test taker exceeds a pace time alert threshold.
Reporting to the control module 901 when a test taker exceeds a pace time alert threshold.
Accessing the question database record 1000 for the question the user is answering to obtain the normal response time or normal response time ranges for answering the question.
Receiving configuration from the control module 901 or configuration data, said configuration controlling intervention parameters, said intervention parameters including the frequency and issue threshold for alerts, tips, messages, and feedback sent to the user by the feedback module.
Accepting configuration of alert thresholds limiting each alert type.
Increasing or decreasing incrementally by a percentage of maximum threshold value, said percentage being a function of test taker's skill level, the alert thresholds when notified by the control module 901 of the accuracy of a test taker's answer and when notified by the pace module 904 of the test taker's pace.
Sending interventions including alerts, tips, messages, and feedback to user interface module 907 and display element 106 for presentation to the user.
Limiting interventions including alerts, tips, messages, and feedback according to time parameters and alert thresholds
Adjusting time parameters and alert thresholds according to the test taker performance, comparing test taker pace for each question and the cumulative pace time according to FIG. 5, FIG. 6, FIG. 7, and, optionally, FIG. 8, and, as disclosed herein, to optimize the alerts and interventions for the test taker.
Adjusting time parameters and alert thresholds according to user configuration of alert thresholds and based on the frequency relayed from the user by the control module 901 during a test or at other times.
Accessing database 908 records.
Communicating with other modules.

### Accessing and Using Configuration Data.

The normalization module 906 is configured with machine executable instructions to include the following functionalities:
Receiving configuration from the control module 901 to determine a normal time or range of normal times for answering each question in the database 908.
Calculate according FIG. 7 or FIG. 8 a normal question pace time or range of normal question pace times for answering each question in the database, and store the calculated normal question pace time or range of normal question pace times in the database.
Classifying in the database 908 the individual answer times and normal time ranges according to the level of test taking proficiency of the individuals who answered each question
Accessing database 908 records.
Communicating with other modules.

### Accessing and Using Configuration Data.

The user interface module 907 is configured with machine executable instructions to include the following functionality:
Receiving questions, messages, alerts, results, interventions, or other information from another module.
Presenting visibly or audibly said questions, messages, alerts, results, interventions, or other information to a user or test taker via user interface/display element 106.
Receiving user or test taker input data and sending the input data to the control module.
Accessing database 908 records.
Communicating with other modules.

### Accessing and Using Configuration Data.

According to an embodiment of the present invention, the system includes computer readable instructions in the form of a normalization module configured to determine a range of normal times for answering each question in the database. The individual answer times and normal time ranges may be classified according to the level of test taking proficiency of the individuals who answered the question. One of ordinary skill in the art will appreciate that answer times may be further classified according to test taker demographics such as age, grade level, school, highest level of education, IQ, or any other suitable demographic.

According to an embodiment of the present invention, the system further includes a time tracking module configured to track the time spent answering a question from the database. In an exemplary embodiment, a user is presented with one or more questions and the time tracking module keeps track of the time the user takes to answer each question. In a preferred embodiment, the database of questions comprises complete sample tests designed to simulate standardized exams such as the SAT, ACT, GMAT, GRE, MCAT, LSAT, or any other test. Alternatively, a database of test questions may be customized for a user. The database questions may also be organized according to various categories, such as math, science, reading comprehension, grammar, language, or any other subject. A user may optionally pick and choose questions to answer from one or more categories, or may elect to take a part or complete simulated exam. In an embodiment of the present invention, customization of a test question database for a user may be automatic, based on a test-taker's historical performance as measured by prior test prep sessions, or based on remedial goals for a test taker, according to a test-taker account or other identification. In a further embodiment of the present invention, for remedial purposes for overcoming academic performance errors and for overcoming weaknesses where pacing errors were discovered in prior sessions, a test question database may be customized for a test taker with specific types of questions having IRT parameters with specific values or in a range wherein the test taker exhibited pacing or performance errors in previous test prep sessions. One of ordinary skill in the art will appreciate that the system and method described herein may be used and configured in many different ways for simulated computerized tests, actual live tests, and test preparation scenarios, administered on a computing device, without departing from the teaching described herein.

According to a preferred embodiment, the system includes a pace module in communication with the time tracking module and results assessment modules. The pace module provides a pace indicator which compares the amount of time spent by the user on one or more questions to the normal pace for answering the one or more questions. For purposes of this application, the term “normal pace” may include a range of normal times or a single normal time. In one embodiment, the pace indicator is a counter for indicating which question number the user should be answering if proceeding at the normal pace. Alternatively, the counter may be a number that indicates how far ahead (positive number) or behind (negative number) a user is relative to the normal number of questions that should have been answered at a particular point in time. In another embodiment, the pace indicator may be a numeric time display of any useful mode of pace time, such as current global pace time, test-taker offset from pace time for a question or a test, pace time remaining for a question, pace time remaining for a test, or any other form of pace time. Optionally, the pace indicator may display multiple such pace times, either simultaneously, or one at a time in a sequence, either as configured or requested by a test-taker or as configured by the system. One of ordinary skill will appreciate that the pace indicator may assume other forms besides a counter or numeric timer, such as a computer graphic, a sound, a color, an animation, or any combination thereof.

According to an embodiment of the present invention, the system also includes a feedback module in communication with the pace module, time tracking module, and the results assessment module. The feedback module provides a user with feedback for improving their pace of answering questions. For example, if a user's pace for answering a series of questions is substantially below the normal pace for answering those questions, the feedback module may provide tips, techniques, or strategies for answering the questions more quickly. The type of feedback may depend on the types of questions, subject area, complexity, the normal pace, allotted time per question, or some other factor. Feedback may be presented to the user in any number of forms including pop ups, scrolling text, or audio/visual presentation. In a preferred embodiment, pop ups are used to provide feedback to the user between questions, so as not to distract the user while answering questions. In addition, the test may be paused when feedback is provided, so that the user does not lose time while receiving the feedback.

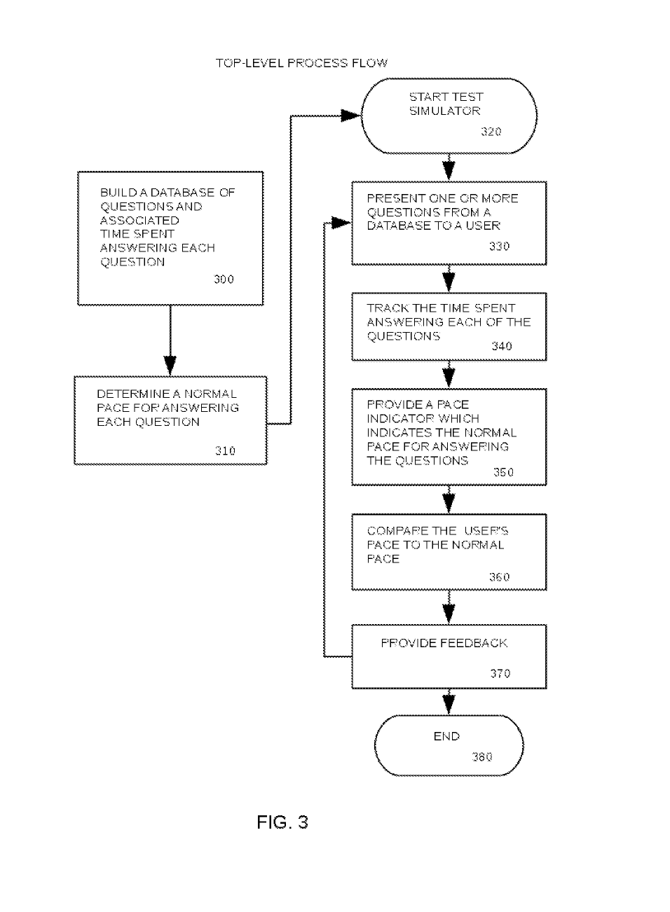

Turning to FIG. 3, the figure depicts a method of providing a pace indicator for gauging one's pace while answering test questions and providing feedback for improving one's pace in an exam. At step 300 a plurality of test questions are collected and stored in a database along with information about the time spent by past test takers who answered each of the questions. At step 310, a normal pace is determined for answering each question correctly. The normal pace may be based on an average of times spent on each question by individuals who answered the question correctly and completed the test within the allotted time. A person of ordinary skill will appreciate that other statistical methods may be used to calculate a normal pace such as median, mode, interquartile range, variance, standard deviation, or a combination of these, or other statistical methods (adjusted for skill level). Furthermore, a normal pace may be a single normal time or range of normal times for answering one or more questions.

At step 320, a test question simulation session is initialized. At step 330, one or more questions from the database are presented to a user. At step 340, the system tracks the time spent answering each of the questions. At step 350, a pace indicator is provided, which indicates the normal pace for answering the questions. At step 360, the user's pace is compared to the normal pace to determine whether the user's pace is too fast, too slow, or appropriate. If a user's pace is faster than the normal pace and one or more answers are incorrect, this would indicate that the user is not spending enough time on the questions. On the other hand, if a user's pace is slower than the normal pace, this would indicate that the user is spending too much time on the questions. At step 370, feedback is provided to the user based on the results of the comparison. At step 380, the user can either exit, or continue answering more questions by looping back to step 330.

The pace indicator is used to indicate whether and to what extent a user's pace is different from the normal pace. In a certain embodiment, the pace indicator includes a counter showing the question number that a user should be working on if the user were proceeding at a normal pace. Alternatively, a different type of counter may show the total number of questions the user is either ahead or behind relative to the normal number of questions that should have been answered by that instant. The pace indicator may be colored to indicate the current status of a user's pace (i.e. too fast, too slow, or normal). For example, red could indicate that a user's pace is too slow, while green might indicate that the user's pace is acceptable (i.e. within a normal range, or close to a normal range). The pace indicator may also include a graphic image, icon, animation, or any other suitable object to visually depict the user's pace relative to the normal pace.

In addition, the feedback module may generate feedback for the user about how his/her pace compares to past users or test takers. For example, the system may generate an alert such as: “Your pace is slower than 90% of students at your skill level.” The feedback may further include a graph or chart which plots the user's pace compared to one or more past test takers. The chart may also compare a user's pace to an average pace of past users/test takers or the normal pace. The feedback may also include comparisons of the user's pace to other users/test takers in specific categories, such as those at the same skill level as the user.

In a certain embodiment the feedback module of the present invention may be configured to report various probabilities, such as the probability of a user finishing the test on time, not finishing on time, hurrying at the end, or finishing without hurrying at the end. “Hurrying” is defined as having to answer the last few questions at a statistically faster pace, such as 1.5 standard deviations above the user's average pace. However, one of ordinary skill will appreciate that a hurried pace may be defined as any other standard deviation from the user's average pace, or some other statistical/numerical difference from the user's average pace. Other reported data may include the percentage of past users/test takers who “hurried” during the test (i.e. hurried on one or more questions) and how their hurried pace compared to the user's pace. Or the feedback report may include the percentage of past test takers who worked at the user's pace who had to hurry at the end of the test. For example, the pace indicator may provide the following alert: “90% of Students at your pace were hurried at the end of the test. Try to increase your pace.” For purposes of this application, alerts, messages, graphs, charts, reports, presentations, links, explanations, tips, techniques and strategies are all forms of feedback that may be provided by the system.

According to an embodiment of the present invention, the pace indicator indicates whether a user's pace is faster than the normal range. Answering questions too quickly results in “loitering” or finishing so quickly that the user has an ample amount of extra time at the end. In this case, the system may generate feedback to encourage the user to spend more time on questions. For example, the feedback module may provide the following message: “90% of students at your pace had extra time at the end of the test. Try to decrease your pace and be more careful.” However, if a fast paced user is answering the questions correctly, this message will not be triggered. In the event a user is answering questions at a faster than normal pace and performing well, the system may still evaluate the user's pace relative to other test takers of the same skill level.

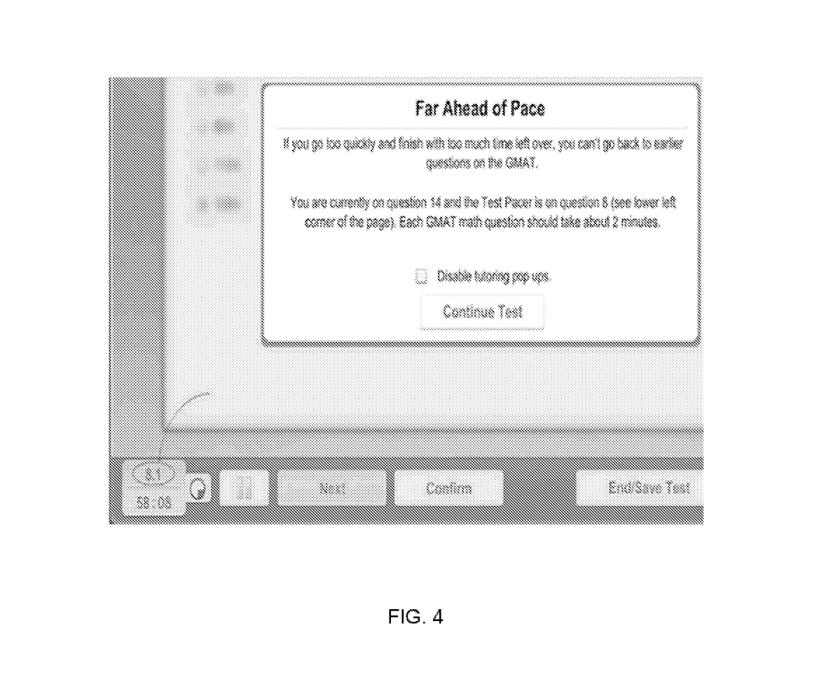

The timing and content of feedback may be based on what is considered most effective or yields the greatest improvement in a user's pace. In an exemplary embodiment shown in FIG. 4, the feedback module may provide the following text alert: “You are currently on question 14 and the Test Pacer is on question 8 (see lower left corner of the page). Each GMAT math question should take about 2 minutes.” In this embodiment, the pace indicator (also known as the Test Pacer) displays a counter in the lower left corner that indicates the question number that a user should be answering if they were proceeding at the normal pace. FIG. 4 also shows a timer displayed below the pace indicator. The timer indicates how much time is left to complete the test.

As discussed above, the feedback module provides feedback to a user if his/her pace deviates from the normal pace. The feedback module may be configured to issue feedback based on the degree of deviation from the normal pace. For example, if a user's pace is more than one standard deviation from the normal pace, a feedback alert may be triggered. The degree can also be measured in terms of number of questions separating the user from the pace indicator counter. As discussed previously, the counter may indicate the question number the user should be working on if they were proceeding at the normal rate, or alternatively, it may indicate the total number of questions the user should have answered up to that point. Feedback may include tips, techniques, or strategies for improving the pace of answering questions. Moreover, feedback may be in the form of a pop-up, text message, graphic, animation, audio recording, audiovisual presentation, or any combination thereof. In a preferred embodiment, a pop-up with tips, techniques, or strategies appears between questions, so as not to distract a user while answering questions. In addition, the test timer may be paused when feedback is given, so there is no loss of time while the user receives feedback. The feedback feature may optionally be disabled by a user if desired.

According to an embodiment of the present invention, the feedback module also provides an alert if a user's pace is faster than the normal pace and one or more questions are answered incorrectly. In this case, the feedback generally includes a warning to be more careful in answering the questions. For example, the following message may be provided: “You took X seconds and got the answer wrong. Unless you are short on time, be sure to check yourself.” In this example, X represents the actual number of seconds taken to answer the question. In an exemplary embodiment, one or more of the following additional tips may be provided:
1) The GMAT tries to fool you into impulsively jumping at trap wrong choices.
2) Try to make sure to review all answer choices before making a selection.
3) Avoid hurried careless errors.

A person of ordinary skill in the art will appreciate that any other appropriate tips or strategies may be provided to a user to help them improve their pace while correctly answering the questions.

In addition, the system is configured to detect careless or baited choices by the user when answering questions. For example, if the user is working at inappropriately fast pace and making careless mistakes, an alert may be generated stating that the user is making mistakes due to hurrying. Since different questions take different amount of time to answer, the alert message will vary according to the type of question and will include specific tips/strategies for dealing with that question. For example, in a reading comprehension question, the following alert may be generated: “You have spent more time than 95% of students on this question. Try to skim the essays better and make notes on each paragraph to move quicker. Try to make a decision and move on to another question.”

Alerts with other known strategies and tips may be generated based on a user's pace and incorrect answers. For example, changing answers from the correct answer to an incorrect answer and spending too much time on the question may generate an alert such as the following: “Statistically, your first answer is usually correct. You spent 2 minutes on this question and are behind pace, so be careful not to waste time changing answer choices.”

A streak of incorrect answers may also generate an alert, especially if the streak is anomalous for the user. An alert advising the user to “cool off” before continuing may be generated in this instance. Similarly, a user may overlook short cuts or fail to skim long passages, thus spending excessive time on one or more questions. Statistical methods may be employed to identify these shortcomings. For example, if a user is taking longer than 90% of previous test takers to answer a set of questions, a warning in the form of a color change may be triggered. The color change may apply to the pace indicator counter, the background, text, or other objects on the screen. If a user is taking longer than 95%, an alert may be generated advising the user to look for short cuts, or try skimming passages. One of ordinary skill will recognize that other types of signals besides color changes or message alerts may be used to notify the user that his/her pace is too slow. Furthermore, other triggering conditions aside from the noted percentages may be utilized. In a preferred embodiment, clicking or selecting the pace indicator counter, or a separate pause button, will pause the test timer and trigger a pop up message showing the user's current pace.

For certain types of exams, such as the GRE or SAT, a test taker can revisit earlier questions that were skipped, or change an answer. In these cases, a counter that displays the question number a user should be answering will not suffice, since the user may be answering questions in a non-sequential order. In these cases, the pace indicator counter is preferably a positive or negative number that indicates the number of questions the user is ahead or behind the normal pace. For example, if the normal pace is 20 answered questions, and the user is on question 12, the counter should be −8.

Alerts may also be generated if a user is taking too much time on an individual question, regardless of whether the overall pace is normal or close to normal. Each question will have an associated normal time or normal time range. Therefore, if a user is spending too much time on a question the user may receive an alert. The feedback module may also advise the user to work on easy questions first before answering harder questions to help the user keep pace with the normal pace count.

According to an embodiment of the invention, the feedback module may also generate alerts for poor performance. For example, if a user consistently falls into a statistical percentile of slowest performing test takers, alerts could be adjusted to account for the user's habitually slow pace. For example, time parameters could be adjusted to help a user improve their pace. Poor performing students at risk on test day may also receive suggestions to take other sample tests, or may receive links to tutorials. As discussed earlier, overall performance can be gauged relative to other past test takers for an assessment. In addition, links to articles on pacing strategies may be provided to help improve a user's pace.

In a certain embodiment a student's pacing performance can be graphed and this graph function might be exclusive or emphasized if the user's performance is poor. The graph may also highlight questions where the pacing problems has occurred. In addition, tutors of the student may get email notifications if the student is at extreme risk of having problems on test day.

The system of the present invention also includes a results assessment module in communication with the pace module and the feedback module. The results assessment module polls students to see if their test problems persisted after test day. The polling data can help facilitate improvement of pace module functionality for effective performance on test day and improve the pacer alerts. For example, test-takers may be polled after, on a break during, or before a test, to evaluate the test-taker's assessment of the usefulness, effectiveness, relevance, appropriateness of timing, or appropriateness of content, of any alerts, hints, suggestions, proposed strategies, or other information or interventions provided by the system during a test, and the resulting poll data may be used to modify the configuration of the pace module and the normal times or normal time ranges used to provide more effective custom interventions. The results assessment module may analyze the calculated normal pace times or normal pace time ranges for quality control and improvement purposes, by statistical or other comparison with measured test taker response times, or the calculated normal pace times or normal pace time ranges may be analyzed by comparison with historical test taker response times from internal or external databases, and the calculations of normal pace times or normal pace time ranges may be adjusted to make the calculated normal pace times or normal pace time ranges more effective as a measure of test-taker performance.

In a certain embodiment, the system include a Mock Test Mode. Students may disable all coaching functionality and enter the Mock Test Mode which looks and feels exactly like the test being simulated. Comments may be available in the explanations, but not during the test itself, where they are not active.

Turning now to FIG. 5, an exemplary process flow for various scenarios is shown. In particular, FIG. 5 details times in which a custom intervention (i.e., custom alerts) could be utilized. For instance, the system could provide a custom intervention when: (i) the student finishes a question far behind pace; (ii) the student has excessive pace time on an individual question and the student is behind pace; (iii) the student changes an answer to an incorrect choice; (iv) student finishes a question very far ahead of pace, as shown in FIG. 4; (v) student is somewhat behind or ahead of pace and limited time remains for last minute course corrections; (vi) an incorrect choice is made and the student spent minimal pace time on the question; or any combination of the foregoing. One of ordinary skill in the art would appreciate that there are numerous types and triggers for custom interventions, and embodiments of the present invention are contemplated for use with any type or trigger for custom interventions.

FIG. 5 illustrates custom intervention in accordance with an embodiment of the present invention using data 500 saved from prior students to create a profile for each question for time spent to solve and accuracy, for comparison 501 with user's time spent to determine if the user is more than two standard deviations away from the average time spent on that specific question for the user's skill level. If the user is more than two standard deviations away from the average time spent on that question, the user is flagged as outside of Normal time on a question; the user could also be determined as outside of Normal time on a question with any statistical measure or technique other than standard deviation as described herein, or by comparison to a configured time. This is to determine if the user is spending an unusually significant amount of time on the question, yet is also behind Pace Time (when time is more precious). So, a student who is far ahead of pace should usually not be flagged for using his extra time on a question. The boundaries of “Normal Time” may be used arbitrarily assigned to certain question types, individual questions and their role. For example, the first question of a Reading Comprehension series may allocate more time. The advantage of “hard and fast” rules for questions is that they are clear to the student (and may even be set by the student for each question type as an option). The student's time is compared 502 to Pace Time as a global variable, and if the student is behind global Pace Time, a custom intervention 507 may be issued in accordance with an embodiment of the present invention. This is to determine if the student is significantly behind pace and likely to not finish the test on time. This amount of “Pace Time” questions can be a fixed value (5 questions behind pace) or it can be specified by a statistical analysis of students who finished the test on time to measure if the student's current position is several SD behind normal pace, or a combination of both parameters (to prevent being flagged for being behind Pace Time on an early question); the user could also be determined as outside of normal pace on a question with any statistical measure or technique other than standard deviation as described herein, or by comparison to a configured time. If the student changed an answer to an incorrect choice 505 the student's time is compared 504 to Normal time to determine if student spent time outside of one standard deviation from Normal time on the question; the user could also be determined as outside of Normal time on a question with any statistical measure or technique other than standard deviation as described herein, or by comparison to a configured time. If the student is behind 503 pace time as a global variable, variables are updated to flag student as behind global pace time; in addition, if the user changes his option and is behind pace and spent an inordinate amount of time, then this error is significant enough to warrant an intervention 507. If a test taker is below 506 “Pace Time” by a factor where he is 2 standard deviations behind from the average rate to finish the test on time at the conclusion of a question, then this error is significant enough to warrant an intervention 507; the user could also be determined as outside of Normal time on a question with any statistical measure or technique other than standard deviation as described herein, or by comparison to a configured time. If a test taker is above 508 “Pace Time” by a factor where he is two standard deviations ahead from the average rate to finish the test on time at the conclusion of a question, then this error is significant enough to warrant an intervention 507. If a test taker is behind 509 pace time as a global variable, and 510 less than the average amount of time to finish two questions remains, this may trigger an intervention 507. If a test taker makes 513 an incorrect choice, and 512 spent less than two standard deviations away from the average time spent on a question, then the test taker is outside of Normal Time on the question, and if the test taker is behind 511 pace time as a global variable, this error is significant enough to warrant an intervention 507.

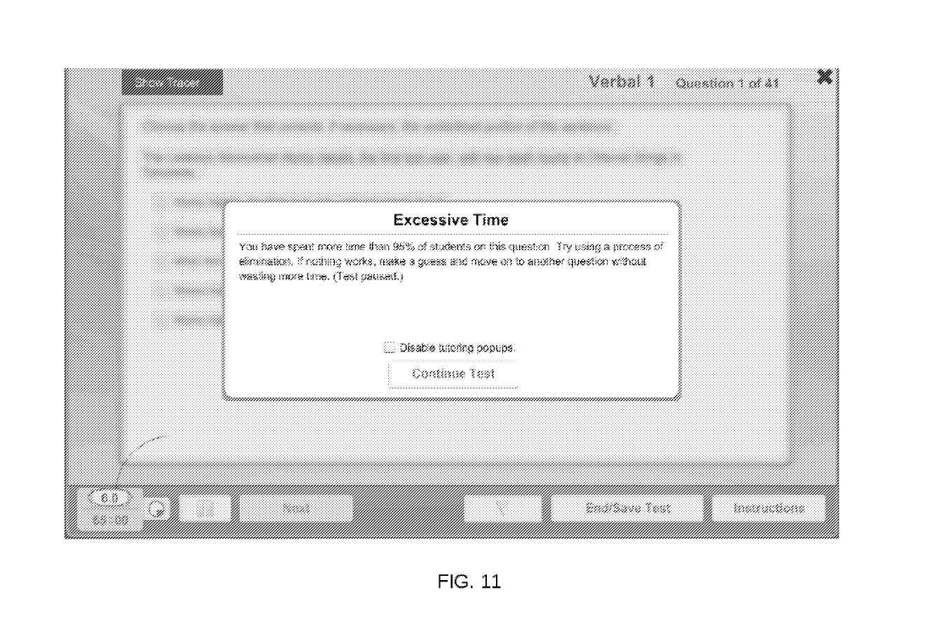

FIG. 6 illustrates a method of improved pacing analysis and tracking, in accordance with an embodiment of the present invention. A test scenario 600 begins with drawing 601 one or more questions selected for a skill level, or one or more randomly selected experimental questions, from one or more databases 908. A question 1000 may be selected from the one or more databases 908 based on one or more parameters or parameter ranges, where said parameters may include: IRT parameters 1003 such as difficulty or skill level, whether the question is of experimental or developmental type 1008; the academic topic 1002 or content type 1001 of the question; historical data about questions collected from testing the questions against populations of test takers, including response times, accuracy statistics, or trap answer significance 1004; population data including population demographic or test score data; data descriptive of the test taker which may be known from a test taker profile and may include past performance, demographic, or other data collected or known about a test taker; data descriptive of goals or objectives of a particular test taker including remediation of weaknesses in specific subject areas, remediation of pacing errors or weaknesses in specific scenarios, or any other parameters, factors, or characteristics known to one of ordinary skill in the art or otherwise disclosed herein, without departing from the teaching of the present invention as described herein. Said skill level, difficulty level, or skill or difficulty level range, or other selection parameters, may be dynamically measured by a CAT or other algorithm in real time during a test or test prep scenario, or said skill level, difficulty level, or skill or difficulty level range, or other selection parameters, may be determined administratively or by configuration as in the case of the initial question of a test in a CAT scenario, when the skill level of a test-taker may not be known, or said skill level, difficulty level, or skill or difficulty level range, or other selection parameters, may be determined by any other parameter, factor, characteristic, or appropriate algorithm known to one of ordinary skill in the art in accordance with embodiments of the present invention. In alternative embodiments of the present invention, one or more questions may be randomly selected from one or more databases 908. In still further embodiments of the present invention, a question selected may be constrained to be of certain types, or constrained to have certain measured parameters or parameter ranges. In still further embodiments of the present invention, a question selection may be constrained so as to exclude certain question types or questions having certain measured parameters or parameter ranges. For example, questions of experimental or developmental type may be excluded from selection and not presented to a test taker in certain scenarios according to embodiments of the present invention. FIG. 16 illustrates a detail view of experimental mode in accordance with certain embodiments of the present invention. The selected question is presented to a test taker. The test taker, also referred to as a user, submits an answer at 602 and the answer is checked for accuracy against correct answer 1005. If the question was answered correctly 622 timing and data are recorded and variables updated, with the CAT Skill Level potentially raised 623 if question was not experimental. If the test is not finished 624 the operation continues with 601 drawing a question from a database for a skill level or randomly selecting an experimental question. If the test is finished 625 data is recorded in one or more databases 908, and the next test task is entered if applicable, or the test exits. Returning for the purpose of description to the point 601 of drawing a question from a database 908 for a skill level or randomly selecting an experimental question, if test time has expired 604 the test ends 625, data is recorded in one or more databases 908, and the test exits. Returning for the purpose of description to the point of checking for accuracy 602 a user's answer to a question, if the question is wrong 603, timing and data are recorded in one or more databases 908 and variables updated, with the CAT Skill Level potentially lowered 621 if question was not experimental, and the method continues with determining 624 if the test is complete. When the user answers a question wrong 603 the user's activity is analyzed 609 to determine if the answer choice was changed, and if so, the user's pacing is analyzed 614 to determine if the user took too much time and is behind pace time; if so, a ‘Changed Choice’ alert may be issued 619. Students often dwell on questions too long and this excessive time paradoxically often decreases accuracy instead of increasing it. Such errors could potentially ruin a test performance by consuming too much time and leaving insufficient time for remaining questions, When the user answers a question wrong 603 the user's activity is analyzed 610 to determine if the user answered unusually rapidly compared to Normal Time, and if so, the user's pacing is analyzed 615 to determine if the user is not far behind pace time, and if the user is not far behind pace time, and took too much time and is behind pace time; if so, a ‘Impulsive Choice’ alert may be issued 620. Further, ‘Impulsive Alerts’ often occur with high scoring students who needlessly hurry through easier questions, so the a difference in skill level of the student and the question may be used to refine this alert with greater time periods causing the problem. High skill levels students often unnecessarily speed through easy questions and these can warrant a custom alert for high skill students to be more careful on easy questions. Skill level may be determined by user query or actual performance. Returning for the purpose of description to the point of processing 602 a user's answer to a question, if the user is ahead of current pace time by two standard deviations or more (for example, or other measurement defined by the test prep company), the user is severely ahead 608 of current Pace Time, and the alert threshold may be lowered 613 if time left is limited, and an “Ahead of Pace” alert may be issued 618; any statistical measure or administrative setting could be used as a gauge to identify the user as severely ahead. Returning for the purpose of description to the point of processing 602 a user's answer to a question, if the user is behind current pace time by two standard deviations or more behind students of his skill level (or other measurement), the user is severely behind 607 current Pace Time to finish the test on time, and the alert threshold may be lowered 612 if time left is limited, and a “Behind Pace” alert may be issued 617; any statistical measure or administrative setting could be used as a gauge to identify the user as severely behind. When a question is drawn 601 from one or more databases 908 and presented to a test taker, and too much time is spent 605 by the test taker, the measured response time or elapsed time of the test taker is compared 606 to Normal time for this question (potentially adjusted by the student's skill level, and if the user is not ahead of Pace Time 611, a “Too Much Time” alert may be issued 616 as shown for some embodiment in FIG. 11. This error would warrant a custom pop up if the student is low skill level and received an unusually high skill level experimental question and wasted large amounts of time on it (a potentially test-ruining event for question that counts for nothing). The “Too Much Time” errors should not occur on the final question of a test (like the GMAT), where the student cannot go back. At least three levels of intervention are used to effectively tutor the test taker with real-time pacing alerts during a test, while avoiding unnecessary disruptions. The most severe errors warrant a popup during a test; less severe mistakes may result in a color change of a pace indicator or question graphic which might be more easily ignored, but a popup cannot be ignored; and the least severe mistakes might only be recorded in the database, with the test taker not notified during the test at all (but afterwards in the explanation text of the question or in the graphics of the pace chart). The different levels of intervention are modulated by test taker skill level, performance, pacing, and position on the test, so that an expert test taker requiring more time to solve a tough question may not receive an alert if already ahead of pace (particularly if the question was correct). The variables determining when an alert is triggered and the type of alert could be determined through anecdotal feedback, test preparation company intuition, statistical measurement of student results, student adjustment of alert sensitivity, and/or by measuring effectiveness in changing results through analyzing decreasing rates of such test prep violations. Our experience is that the parameters are best influenced by student feedback, since the primary goal is not to annoy them or generate so many false positives that the benefits of the software are ignored. When a question is drawn 601 from a database 908 and time has expired 604, the test ends 625.

FIG. 7 illustrates a pace time calculation and measurement method for tracking and analysis of a test-taker's timing performance, relative to Normal time. A first Pace Time 700 is obtained by calculating Pace Time=(time elapsed/total time)*number of questions. So, for example, if two minutes have elapsed on 100 minute test with 100 questions, the Pace Time is 2.000. However, for user student to use (Pace Time Rendered), 1 should be added and the result rounded to one decimal point (making 3.0). This means that the user should have just finished question 2 and just started question 3 (pace time 3.0). So on a 100 question test, the user is finished at 100.9 (101 is never rendered for pace time display since no question 101 exists). A test 701 is performed to determine if some questions are excessively time intensive with median time to complete longer or shorter than pace time. If some questions are excessively time intensive a second Pace Time 702 is obtained by calculating Pace Time using elapsed time and average times as shown in FIG. 7. At step 702, and a Fractional Pace Time is also calculated according to FIG. 7 at 702 Fractional Pace Time remaining after a given number of questions have been presented to a test taker is a function of: Time Elapsed, and the sum of average times of many test takers for the specific questions presented. Also note that normal times for each question are different, because the normal times are calculated from averages of response times by large populations of test takers (ideally among those of similar skill level who finished the test on time with little hurrying and decreased accuracy at the end), and different question types, varying question difficulty levels, and varying test taker skill levels affect the average response time for each question, thus the normal times for answering each question can be different. Fractional Pace Time addresses outstanding questions by creating a summation function (such as a loop) where all questions taken by the student in the test have their “normal” time summed in a loop until they exceed time elapsed (then the loop ceases at a question and that question number is recorded (“end of loop question”). The time elapsed then subtracts the time summation up to the question before the“end of loop” question. This is the integer pace value. The remaining difference is then divided by the “end of loop” question to provide a fraction for the fractional value of the integer. Then add 1. For example, if there were three questions taken by the user of “normal times”: (1) 2 minutes, (2) 3 minutes and (3) 4 minutes, and the user has spent 7 minutes, then the “integer value” is 2. The fractional value is ½ since the user is 2 minutes into question 3 (which is four minutes long). Then add 1 to get 3.5 as the Fractional Pace Time. If the loop exceeds the question that the user is on, then the average time for questions remaining, OR average time for questions in the test, is used (if the student is targeting fast questions to start, the former is more accurate since it can be assumed that the student will be targeting the “fast questions”) to stand in for questions completed in the loop. In this case, if 12 minutes have passed and the first three questions are 2 minutes, 3 minutes, and 4 minutes, then the stand in for question time of questions not reached would be 3 minutes (average). Fractional time would loop to 4. Add 1 to get a value of 5. This value is useful if the front of the test is front loaded with time-intensive/or very quick questions far exceeding/or going below the average time value of a question on the test. This function may be an option if it is a timing strategy that the student wants to use (doing the quick questions first). So, if the first 10 questions completed are 30 seconds “normal time” and the last 10 questions are 3 minutes each, then this system would provide a more useful guide than standard “Pace Time.” On some tests, like the GRE, students skip to the “quick” questions to rack up as many points as possible before moving on to the weighty essay passages. This“Fractional Pace Time” can advise a student and Virtual Tutor alerts even when such complex strategies are used where a simple linear Pace Time would be inaccurate since it assumes the same time for all questions. Thus, Fractional Pace Time can be used as a training tool for teaching this optimal time management of skipping to lengthy questions on tests like the GRE. Normal Time is calculated according to FIG. 7 at step 703 as two to four standard deviations above and below average from time spent to solve question, solve question correctly or incorrectly, or for a given answer choice, for a given question, or may be a normed value by question type, student selection or editorially made by the test prep company. Normal Time as calculated according to FIG. 7 is normal question pace time. Normal test pace time is the sum of zero or more normal question pace time, and in some scenarios may be: a sum of normal question pace time for all the questions in a complete test, or a sum of normal question pace time for all the questions completed by a test taker up to a point in time as computed during a test in progress. Another way to state the definition of Normal Time is that Normal Time for a question can be a statistical range of a sum of average times of many test takers who finished the test without diminished accuracy for hurrying for each question, and Normal Time for a plurality of questions such as for a test is a sum of the plurality of question Normal Times or Normal Time ranges. Minor adjustments may be made from test-to-test, such as tests where the many users might not want to try to do all the questions.

FIG. 8 illustrates alternative methods for Normal Time calculations in accordance with embodiments of the present invention. Note that as described in FIG. 7, the values of “Normal Time” may be defined by the test maker as specific values based on user experience and feedback and not necessarily algorithmically generated. This will be beneficial as the that time is fixed and that students generally approach tests with memorized times based on the time allocated for certain question types. So, for example, the first question of a Reading Comprehension series may be assigned 10 minutes as the excessive “normal time” for those questions prior to triggering an alert or notice. Other Reading Comprehension questions or Critical Reasoning may be five minutes for the maximum “normal time.” A greatest may be constructed for a test taker with customized Normal Times by collecting 800 all question types for a test and allowing a test designer to 801 assign Normal Time Range Values for the test using multiple methodologies including: arbitrarily; corresponding to test taker skill level; and, corresponding to statistical characteristics of one or more test taker. In an alternative embodiment questions and Normal Time Ranges may be customized 802 by a test taker selecting questions 803 from pull-downs, with the user having an option 804 to assign pace values, or configure 805 the test-taker's normal time range for individual questions, which the test preparation system 900 will use for pacing calculations. The advantage of this system is that the alerts are consistent and it helps to generate a fixed sense of time for the user rather than alerts being generated by somewhat random database data for individual questions.

Referring now to FIG. 3 and FIG. 9, in certain embodiments of the present invention, at step 300 test questions 1000 are collected in a database 908. A database 908 of test questions 1000 may be configured in various ways: for a CAT scenario with questions of all difficulty levels, or with or without experimental questions, or customized for a test taker in accordance with performance or remedial goals, or customized for a test taker based on previous test taker results or test taker demographic or profile data. At step 310 a normal pace for answering each question is determined. The control module 901 may configure the normalization module 906 to determine a normal pace for answering each question, or the control module 901 may use previously determined normal pace data from question database records 1000. In still further embodiments, control module 901 may use previously determined normal pace data from a constrained population of test takers; in non-limiting examples, the configured normal pacing data may be from test taker's with specific academic or professional credentials, or the configured normal pacing data may be from test taker's who achieved a minimum score on an exam such as the GMAT, or the configured normal pacing data may be from any other defined subset of test takers. In some embodiment of the present invention a test starts at step 320 when the control module 901 reads a test configuration from a database 908. The test configuration describes the test parameters including: content, number of questions, time limits, and test modes, said test modes including: Experimental modes; Adaptive modes; Mock Test modes; and diagnostic modes. Experimental modes include experimental questions that may be randomly selected and delivered during a test, with a percentage of the total test questions being experimental questions that do not count toward a test taker's score and do not affect the adaptive skill level (CAT) algorithm estimate of a test taker's skill level; thus, Experimental mode operates like the real GMAT. In Adaptive modes, a test taker may configure the number or percentage of experimental questions, or choose to have non-experimental questions with a specified skill level or skill level range delivered in place of experimental questions, while preserving the property of adaptive mode that experimental questions or non-experimental questions with specified difficulty levels that are delivered in place of experimental questions do not count toward a test taker's score and do not affect the estimate of the test taker's skill level calculated by an adaptive question selection (CAT) algorithm. In Adaptive modes scoring of a test taker's answers, pace time analysis and tracking parameters, and question selection may be adjusted, to customize the percentage of experimental questions in a test, and adjust scoring so that a test-taker's score is comparable to a real test. As a non-limiting example, if in an Adaptive mode test, there are no experimental questions, and thus more questions counting toward a test taker's score, the question selection by CAT or other algorithm may have parameters adjusted to adapt the skill level more, or less, aggressively, to reach the harder or easier questions faster or slower; in addition, scoring of a test taker's answers may be adjusted in Adaptive modes by scaling question values to make individual questions count less toward the overall score since there are more of them, so that the test score is comparable to a real test that would include experimental questions; this makes the test taker's score in an Adaptive mode test a better predictor of the score on the real test day. In Mock Test Modes, alert and feedback functionality may be turned off. At step 330, one or more questions selected from a database are presented to a test taker. One or more questions to be presented to a test taker may be selected by control module 901 according difficulty level. In some embodiments of the present invention one or more questions selected by control module 901 to be presented to a test taker may include one or more experimental questions. If engaged in a CAT scenario and the question is other than the initial question, and the test taker's skill level is known, a question may be selected by difficulty or other IRT parameters, according to a current estimate by a CAT algorithm of the test taker's skill, or, for the initial or first few questions, control module 901 may determine an initial skill level or other IRT parameters for choosing an initial question from: configuration data; student profile data such as demographic data; the test-taker skill level measured by the present invention in a previous CAT scenario; a skill level configured by a test administrator or configured by the student; or, the initial skill level may be statistically chosen from test taker population or question data such as a mean, median, or percentile. In some embodiments the control module 901 may initialize a CAT algorithm with said initial skill level or other IRT parameters. In some embodiments control module 901 may select, depending on configuration of control module 901, one or more question 1000 from one or more databases 908 according to certain criteria for question selection, including: at random; according to a CAT skill level measured in real time by a CAT algorithm and depending on: test-taker's accuracy on the previous question; the current CAT skill level; and, question IRT parameters; or, question 1000 may be selected according to: a specific difficulty; IRT parameter value; range of difficulties or range of IRT parameter values; or question type, such as Experimental question type. Control module 901 configures feedback module 905 with the question database record or records 1000 to be presented to the test taker. At step 340 the time spent answering each of the questions is tracked. The Control module 901 configures feedback module 905 with the normal time or normal time ranges for answering question 1000. Further, the Control module 901 sends selected question 1000 to user interface module 907 for presentation to test taker. Furthermore, the Control module 901 notifies feedback module 905 question 1000 has been presented to the test taker. The Feedback module 905 configures pace module 904 with the normal time or normal time ranges for answering question 1000. In an embodiment, in which the one or more questions presented to a test taker comprise an experimental question, in a non-limiting example, feedback module 905 may configure pace module 904 with the Global Pace Time per question, which as described previously is calculated by simply dividing the time for the test by the total number of questions, as the normal time or normal time range for pacing alerts for experimental questions, or in some embodiments pacing alerts may be turned off or otherwise limited on a per-question basis for experimental questions. At step 350, a pace indicator is provided which indicates the normal pace for answering the questions. The Feedback module 905 configures pace module 904 to start tracking the test taker's response time in answering question 1000. Further, Pace module 904 configures time tracking module 902 to start a timer to measure the test taker's response time answering question 1000. The Pace module 904 provides on user interface 907 a pace indicator which compares the amount of time spent by a test taker on one or more questions 1000 to the normal pace for answering one or more questions 1000. The Feedback module 905 and pace module 904 may provide alerts or feedback on user interface 907 to the test taker according to: FIG. 5; FIG. 6; and, according to the disclosure herein, as a function of: the time spent by a test taker answering question 1000; the configured normal time or range of normal times for answering question 1000; the current pace time and normal time which may in some embodiments be calculated by pace module 904 according to FIG. 7 or FIG. 8; and, the configuration and state of alert and intervention thresholds configured in: the control module 901; the feedback module 905; and, the pace module 904. Alerts or feedback may be sent by the feedback module 905 or the pace module 904 to the user interface 907 for presentation to the test taker both when the time the test-taker is answering a question, and after a test taker submits a response to user interface 907. In some embodiments alerts and feedback are turned off in a Mock Test Mode. Alerts, feedback, and interventions may be also limited by adaptive thresholds in: the control module 901; the feedback module 905; and, the pace module 904, to avoid sending some alerts too often, and otherwise may be customized for a given user on a given test, according to FIG. 5, FIG. 6, and the disclosure herein. In a non-limiting example, alert thresholds may be incremented or decremented by feedback module 905 by a percentage of maximum alert frequency or sensitivity, based on the test taker's skill level, so that more highly skilled test taker's receive fewer alerts, and lower skilled test taker's receive more alerts. Time per question for triggering alerts is function of test taker skill level. So, if you are a top student, you should spend less time on easy questions (and the alert system should acknowledge this). If the question is easy for your skill level, you are more likely to get an alert. Or, a top student hurrying through an easy question may make this same error by making a careless error. Thus, alerts for too much time are adjusted by difficulty level of the question and skill level of the test taker. Test taker submits a response to user interface 907. User interface 907 forwards test taker's response to control module 901. Control module 901 notifies feedback module 905 test taker has submitted a response to question 1000. Feedback module 905 configures pace module 904 to stop tracking the test taker's response time in answering question 1000. Pace module 904 configures time tracking module 902 to stop the timer measuring the test taker's response time answering question 1000. Pace module 904 obtains the test taker's response time answering question 1000 from time tracking module 902. Pace module 904 updates the pace indicator on user interface 907 with the test taker's pace time on the question just answered. Control module 901 checks test taker's response to question 1000 for accuracy. Control module 901 configures feedback module 905 with accuracy data for the question 1000 answered by test taker, said accuracy data including: whether the question was answered correctly; whether the answer choice was changed to a correct or incorrect answer; and, trap answer significance. Control module 901 stores result data in one or more databases 908. In some embodiments of the present invention, control module 901 may execute one or more CAT algorithms with input including: the difficulty level of the last question; last question IRT parameters; the estimate of test taker's CAT skill level before answering the last question; historical or time-averaged estimates of test-taker skill level; and, whether or not the test-taker answered the last question correctly; and the one or more CAT algorithms may change the current estimate of the test-taker's skill level. In some embodiments, the CAT algorithm estimate of a test-taker's skill level may be used to choose the difficulty of the next question. In some embodiments, such as when the percentage of experimental questions is varied or even set to zero by configuration, CAT algorithms may be adjusted to adapt less aggressively to a test taker's skill level, to reach the more difficult or easier questions faster or slower to account in question difficulty selection for the varied percentage of experimental questions. For example, if there are experimental questions, the CAT algorithm will make larger leaps since there are fewer questions to hone in on the student's score. In some embodiments, when the percentage of experimental questions is varied or even set to zero, the algorithms used to calculate a test taker's score may be adapted to account in the test taker's score for the varied percentage of experimental questions and the different number of scored questions. In some embodiments, when a question is not experimental, a question answer is checked for accuracy, and the CAT skill level is updated, and the test taker's score is adjusted. In other embodiments, when a question is experimental, a test taker's answer to an experimental question may be ignored; that is, an experimental question may not be checked for accuracy, the CAT skill level not updated, and the test taker's score not adjusted. The experimental mode, adaptive mode, integration of experimental questions, and experimental diagnostics of the present invention directly manipulates the test and optionally adjusts the scoring, and provides results visualization for the test taker explaining the effect of experimental questions on their performance and pacing. In the adaptive mode of the present invention, instead of being presented with randomly selected experimental questions at random question delivery times as in a real test, the present invention adapts the scoring and question selection for non-experimental questions. In the present invention the test taker can adjust the number of experimental questions on a test, including zero experimental questions. Reducing the number of experimental questions or eliminating experimental questions entirely changes the number of questions counting toward the test taker's overall score, and since experimental questions do not count, each non-experimental question must have the score value scaled in adaptive mode to determine the user's score, so the test-taker's score will be comparable to scores in other modes. In addition to allowing the test taker to adjust the number of experimental questions on a test, in an embodiment of the present invention, the test taker can choose a skill level, or a minimum skill level, for questions delivered in place of experimental questions. In experimental mode the test is easier for high skill level students, and harder for low scoring students; in addition, the test performance will be higher in experimental mode for high scoring students (because statistically more randomly selected experimental questions will be easier than their skill level), and the performance will be lower in experimental mode for lower scoring students (since experimental questions will be, on average, harder). An adaptive mode test delivered by the present invention will be easier for lower scoring students and harder for higher level students. The present invention adjusts question delivery and scoring for variable percentage of scored questions per test in adaptive mode in several ways, including: score adjustments by scaling question values (to account in the test taker's experimental mode score for a different number of scored questions and make the scores comparable to real tests); difficulty adjustments to the CAT algorithm and IRT parameters (so that in adaptive mode question delivery parameters are adjusted to get to the harder or easier questions quicker to account for the different number of scored questions by converging more rapidly, for example, with higher adaptive sensitivity to test taker response accuracy and question difficulty, to a test taker's skill level); performance is analyzed and the performance analysis conversion customized for the experimental questions to ensure that scores correlate with actual GMAT scores despite the change in test content (different performance databases are required for experimental and adaptive versions); and, students are polled prior to taking a test to ensure accuracy by linking their performance to prior tests. Adaptive mode requires distinctive database notation for test and recall and statistical analysis of results so that the mode can be analyzed and an accurate score created. GMAT CATs are database intensive, which is how the questions are normed and the scores justified. Further, the experimental questions can be actual experimental questions (random new questions used like the real GMAT for quality assurance and skill-level determination), which may be preselected to simulate a random distribution. In some embodiments, if one or more questions 1000 comprise an experimental question, control module 901 may store in one or more databases 908 a record of the result of presenting an experimental question to a test taker, said result of presenting an experimental question to a test taker including: whether experimental question was answered correctly; response time; whether an answer was changed; scrap work, calculations, or notes created by the test taker while answering the experimental question; or, user activity including any resources or information accessed by the test taker while answering the experimental question. In some embodiments, an experimental question may not be accounted for in the test taker's score, whether or not an experimental question may be checked for accuracy for question development. In some embodiments, results from experimental questions may be used to assess the experimental questions for further question development. At step 360, the user's pace is compared to the normal pace. Pace module 904 reports to feedback module 905 the test taker's pace time in answering question 1000, and feedback module 905 may issue alerts or interventions as configured, according to FIG. 5, and FIG. 6, and as disclosed herein. In some embodiments, at step 370 feedback optionally may be provided to a test taker, optionally with control module 901 displaying results from one or more databases 908 on user interface 907. In some embodiments, results display on user interface 907 may in a non-limiting example include multi-color graphs of a test taker's results: on a per-question basis with an interactive, clickable dot for each question, that when clicked reveals further interactive diagnostic and analytic information about the test taker's pacing, accuracy, handling of experimentals, and the tracking of the adaptive skill level; on a per-test basis, or for a group or batch of tests, or, comparing test taker's results to a population of test takers, or comparing test-taker's results to hypothetical result parameters specified by a test-taker for analysis purposes. In some embodiments, experimental questions are highlighted and graphed in the interactive results display on user interface 907, to permit the test taker to learn from the effect of the experimental questions on their test-taking performance. In a non-limiting example, results graphs may include, on a per-question basis: elapsed time, normal time, pace time per question, excessive pace time used, experimental question locations in the sequence of test questions, CAT skill level or question IRT parameters, inadequate pace time used (hurrying), changed answer choices, points where alerts were suppressed by threshold or rule, and alert threshold values or percentages. In some embodiments, display of test taker results may be interactive, wherein test taker may select and expand or drill into data points in results display on user interface 907 to obtain more detailed views and analysis about their performance on each question, as described above. In a non-limiting example of interactive result display, user interface 907 sends the user input indicating the dot the user clicked on and retrieves the question result data corresponding to the clicked dot, and the operation requested by the user, such as to display additional diagnostic or analytic data as described above, to control module 901. Control module 901 obtains or updates data from one or more databases 908. Control module 901 recalculates result data as required by the requested diagnostic or analytic visualization operation and redisplays for user on user interface 907. A user interacting with a results display may manipulate result data by clicking on dots in result displays on a per-question and per-result basis, and explore and visualize the underlying data. In a further non-limiting example of interactive results display, a user might dynamically enable or disable scoring or not scoring experimental questions, and the score, and results display, is recalculated and displayed in real time in accordance with the user's interaction with the results display. Feedback module 905 and pace module 904 may provide alerts or feedback on user interface 907 to the test taker according to: FIG. 5; FIG. 6; and, according to the disclosure herein, as a function of: the time spent by a test taker answering question 1000 or for one or more questions, or for an entire test; the configured normal time or range of normal times for answering question 1000 or for one or more questions, or for an entire test; the test taker skill level; the current pace time and normal time which may in some embodiments be calculated by pace module 904 according to FIG. 7 or FIG. 8; and, the configuration and state of alert and intervention thresholds configured in: control module 901; feedback module 905; and pace module 904. At step 380 if a complete test of questions 1000 have been presented to a test taker, results are recorded in one or more databases 908, and the test may end, with in some embodiments, results and optionally interactive results, as described herein, presented to a user. If a complete test of questions have not been presented to the test taker, the user may exit, otherwise, the method continues at step 330 with selecting a question for presentation to a test taker.

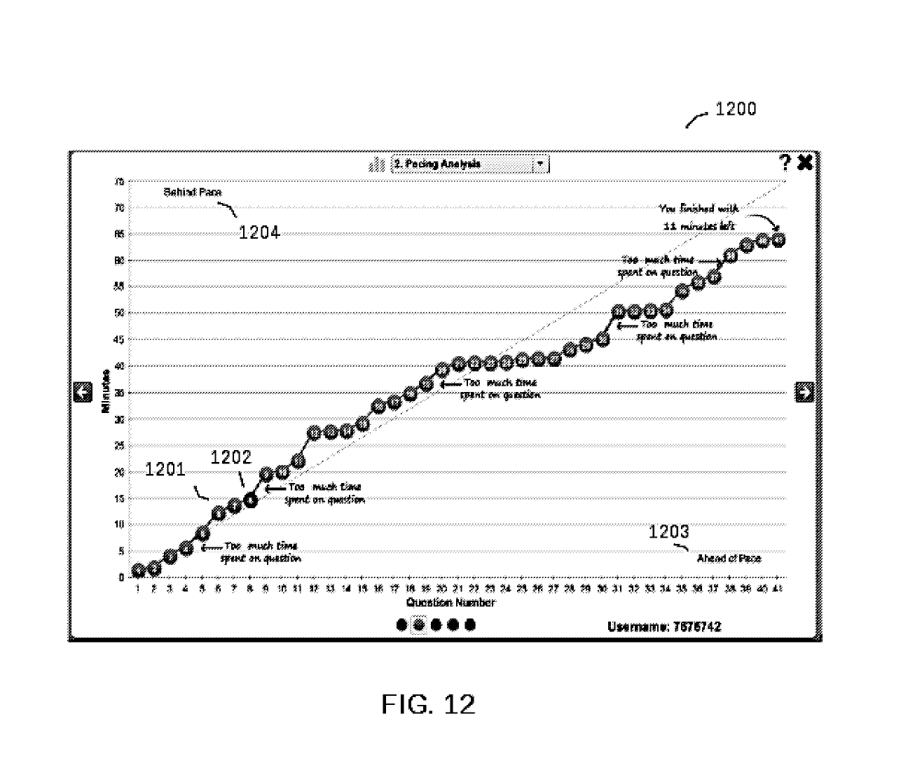

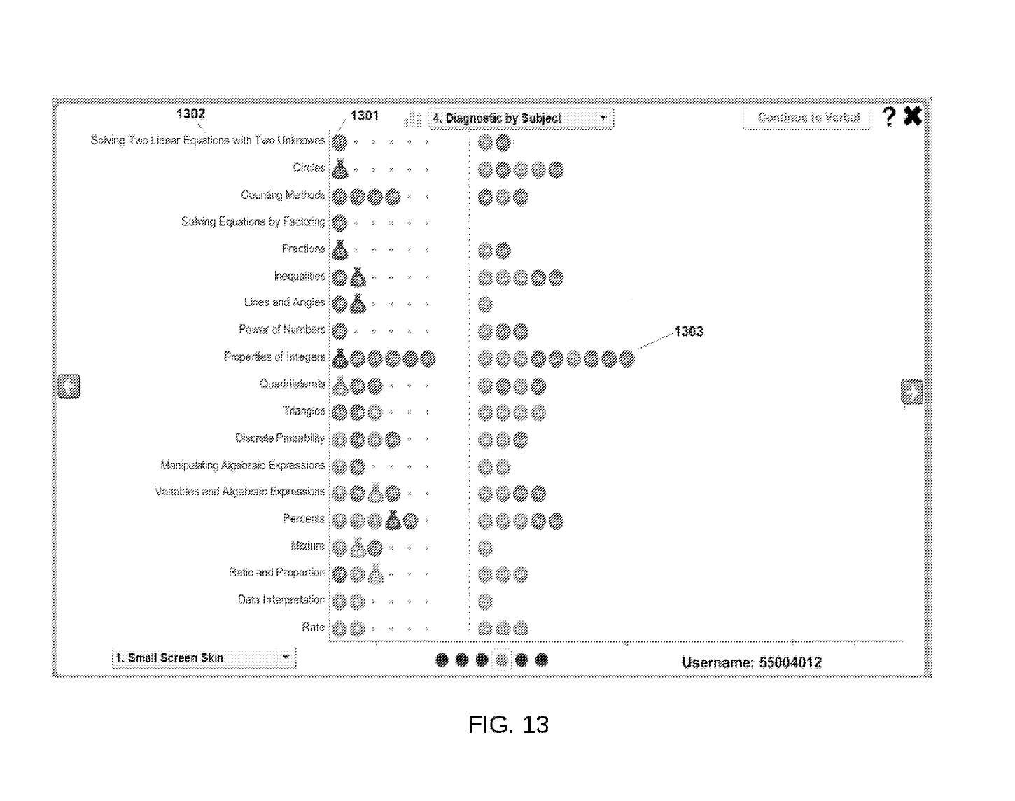

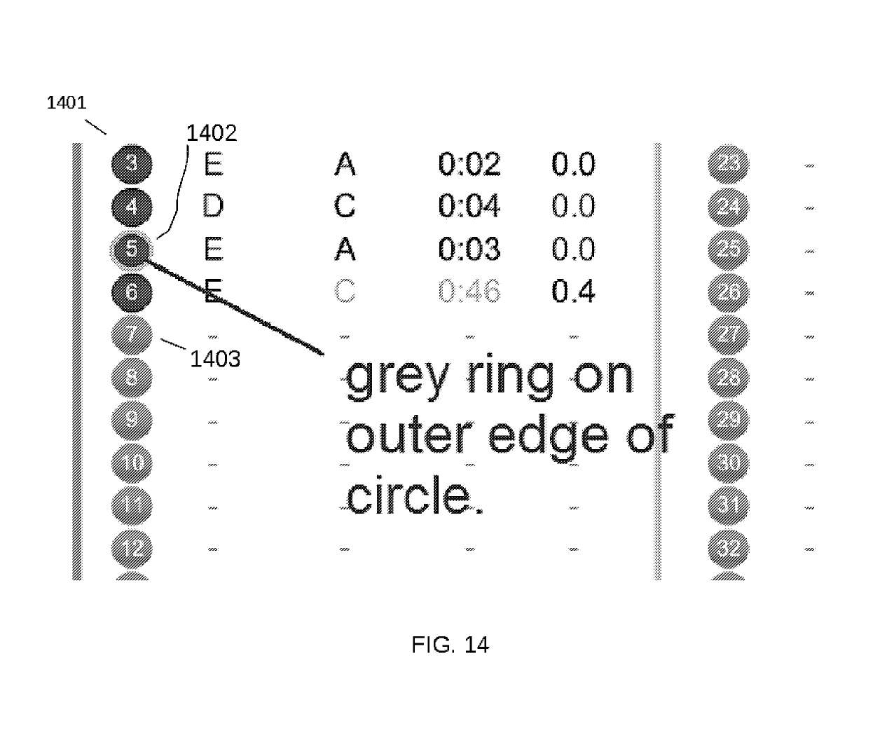

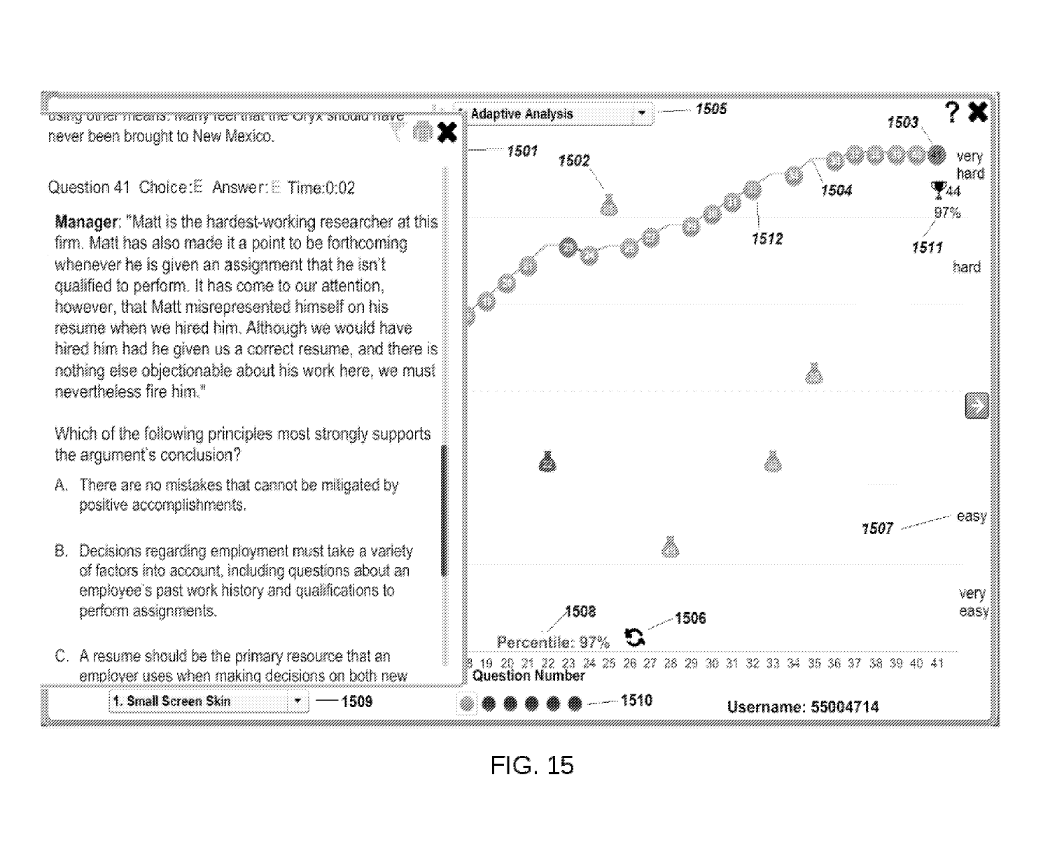

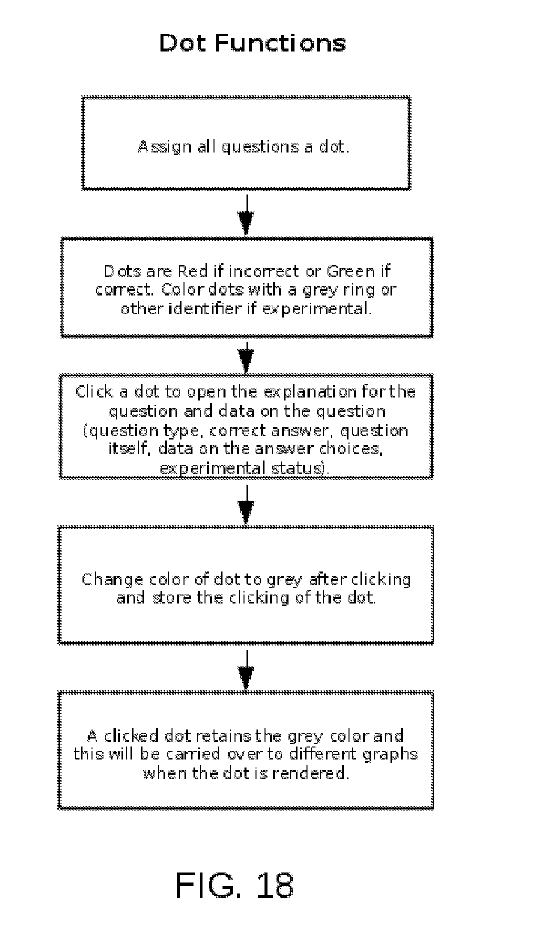

In a non-limiting example, a user may visually interact with and visualize their test results, including pacing, accuracy, scoring, adaptive skill level, and experimental questions, at a per-question level using a feature of the present invention known as Dot Diagnostics, described below. The new dot diagnostic blurs the line between a “diagnostic” and an “explanation page” because each of the dots is clickable to open up the explanation for the specific question. This is a functionality whereby traditional bar graphs are replaced with rows of interactive dots or other graphical representation such as a beaker (for experimental questions), a circle, polygon, or any other shape or form; although the description herein is provided in terms of dots it is intended that any other graphical representation can be used wherever a dot is described in this application. This creates an intuitive and elegant system where each question is represented by a dot across several diagnostic graphs (such as pacing analysis, shown in FIG. 12; break downs by question type, shown in FIG. 13; experimental analysis, shown in FIG. 14; or adaptive analysis, shown in FIG. 15). Since there will be several diagnostic pages, the dots change color subtly after they are clicked to prevent the user from clicking the same questions over again. As shown in FIG. 18, dot functions for all graphs are created by assigning all questions a dot. Dots are Red if incorrect or Green if correct. Dots are colored with a grey ring or other identifier if experimental (such as a beaker shape). Clicking a dot opens the explanation for the question and data on the question (question type, correct answer, question itself, data on the answer choices, experimental status). The data on the question is standard as in the industry with the exception of customization for alerts and related messages. The color of a dot is changed to grey after clicking, and the click event of the dot is retained. A clicked dot retains the grey color and this will be carried over to different graphs when the dot is rendered. This changed appearance of clicked questions is utterly essential for the design because otherwise users would continue to unknowingly click the same dots on different graphs and the system would engender chaos.

In a non-limiting example of interactive pacing results analysis in accordance with embodiments of the present invention, FIG. 12 illustrates a graph 1200 of a test-taker's pacing depicting test taker response times 1201, 1202 per question with an indication of whether each test taker response was behind pace 1204 or ahead of pace 1203. Pacing results analysis graphs are created by plotting dots for each question number (x axis) by the global pace time (y axis). Although FIG. 12 illustrates a diagonal from the origin of the pacing analysis to the upper right corner, wherein dots above the diagonal such as at 1204 are behind pace and dots below the diagonal such as at 1203 are ahead of pace, the diagonal illustrated is representative of graphical pacing analysis for a test wherein a test taker is not allowed to return to previous questions; a pacing analysis graph in accordance with embodiments of the present invention does not need to show a diagonal in the case of pacing analysis for a test wherein a test taker is allowed to return to and answer previous questions. In accordance with embodiments of the present invention, pacing analysis graphs include displayed messages and error indications in user-friendly text where the test taker made pacing errors, such as at 1202 where the alert “Too much time spent on question” is displayed to draw the test taker's attention to the question and highlight their mistake. Different levels of intervention are used to effectively tutor the test taker while avoiding unnecessarily cluttering the data in the analysis graph with alert data. The different levels of intervention are modulated by test taker skill level, performance, pacing, and position on the test, so that an expert test taker requiring more time to solve a tough question may not receive an alert in the analysis graph if ahead of pace, and a lower skilled test taker who is on or even ahead of pace may receive frequent alerts in the analysis graph for even slight pacing errors. Dots are changed in color if clicked on another graph to a grey shade when rendered to indicate that it was previously clicked, and arrow notations are added on the question stems where pacing errors occurred so that users can precisely see where they went wrong. Such timing errors will be visually obvious as huge vertical leaps (for excessive times) and minimal vertical (y-value) increases between dots where hurrying occurred. Further, the fungability of time is apparent where the user slips above and behind pace at certain points. In this embodiment, the user can click the exact question where he made the excessive time errors, to pinpoint exactly where they ruined their pacing, and open up a display of detailed pacing analysis including timing information and statistics for the test taker and populations of test takers, pacing suggestions, tips, or alerts pertaining to the question where the test taker made the pacing error. Further, lines connecting dots may be colored (such as red) if a pacing-related error occurred on the question. So, if the user spent too much time on question #2, the line connecting dots #2 and #3 is colored.

In a non-limiting example of question dot diagnostics in accordance with embodiments of the present invention, FIG. 13 illustrates test taker results for each question organized by subject or question type. Subject or question type results analysis displays are created by plotting dots of questions sorted by question type (geometry, polygons) and the test taker's accuracy, in addition to detailing the types of questions by subject area that represent the test taker's strengths and weaknesses. Dots are changed in color if clicked on another graph to a grey shade to indicate that it was previously clicked. Dot 1301, like 1503, is a symbolic representation of a question. Its design may symbolize a question type or color if the question was correct or incorrect. Dots have identical function as described in 1503, 1512, 1502. The “dots” figures that represent questions and their associated traits. The click status, as described in 1512 carries over. Clicking any question symbolic representation generates explanation data for that question, as described in 1503. The pop up location is dynamic to prevent the pop up from covering the question clicked. 1302 shows an example of common topic areas. In this case they are arranged from top to bottom by decreasing accuracy). This is a common “Strengths and Weaknesses” chart common in the industry. The design shown by 1303 has a unique function where questions from prior tests may be integrated into this diagnostic to create a universal function and this page may screen for difficulty level, too much time spent or other traits common in the industry, such as question type. The title of each subject links to content for that subject. The dots are labeled Q1, Q2 to symbolize the tests they are pulled from (Quantitative 1, Quantitative 2).

In a non-limiting example of experimental question results dot diagnostics in accordance with embodiments of the present invention, FIG. 14 illustrates test taker results 1401 and 1403 for each question highlighting experimental question 1402 with a grey ring as shown.

In a non-limiting example of adaptive analysis in accordance with embodiments of the present invention, FIG. 15 depicts test taker results for each question of an entire test, highlighting the test taker's skill level. 1501 is the question output for question 41; it was triggered by clicking 1503 dot #41. This pop up contains data on the question, including an explanation, time spent, correct answer, incorrect answer. 1502 is an experimental question. Its difficulty level does not follow the algorithm. Its position is characterized by an approximation of the difficulty level (y-axis) (such as relative student accuracy rates) and the question number (x-axis). Like the experimental beaker representation, 1503 Question #41 is represented by a symbolic figure and plotted by a difficulty level (as y-axis) and (x-axis as question number) plot. This dot symbol may be changed to a square or other shape to represent traits of the question. This is a reading comprehension question, which tends to take more time and may use an alternative representation or underlying background design on the pacer page. The text is black in the dot to convey that it is currently open. This question is incorrect (as shown in 1501). So, the dot is red to represent this. Other dots are green to convey correctness. Since the experimental is not present along the CAT difficulty line, there is no dot along the line 1504. There is a grey line following the beaker since experimentals (represented by beakers) do not change the algorithm. The grey line is flat because the experimental does not change the Y value of the question. Other lines use a blue line (always going higher) to represent the causal effect of correct answers resulting in a more difficult questions. Similarly, incorrect questions generate red lines. So, the starting point of dot #1 is at the middle of the page and the line goes up (blue) if correct, to the higher difficulty position of dot #2. If Question #1 was incorrect (red) a red negative slope line would connect dot #1 and the lower position of dot #2 since incorrect answers generate easier questions on non-experimentals. This display functionality has the benefit of teaching adaptive functionality to students and how experimentals work. On tests, like the SAT, similarly, there is no adaptive engine, so the lines between dots need not be colored to covey the lines conveying a change in difficulty level instigated by the user getting the question correct or incorrect. Since users can go backwards on the SAT to prior questions, these arrows connecting dots can have small arrows to symbolize user progress and a changing shade as more time elapsed to convey progress. This pull down 1505 changes the diagnostic page to other pages, such as FIG. 13 or FIG. 12. 1506 Dots may render in a left to right fashion to simulate a re-creation of the actual student experience of the algorithm finding the user's score with the dot and line rendering matching the fraction of time elapsed for the entire test in pace time. Dots rendered from the starting point to the ending point. So, for example, all questions could be rendered in 3.7 seconds for a 37 second test where each question is rendered after tenths of a second corresponding to the pace time value of each question upon its completion. This allows the user to replay how they conducted their test in a fashion that replays their timing. The refresh icon re-executes this functionality. The replay function may be used on FIG. 12 as well to render progress in the pacer chart to recreate the student's pacing in a visually dramatic and time-scaled fashion. This replay function is particularly useful on non-linear tests, like the SAT, because the user can follow their zig-zag progress through the test from question to question both backwards and forwards. These light grey lines 1507 demarcate difficulty vertical zones (very hard, hard, medium, easy, and very easy in this embodiment). The Y axis is difficulty level and it is labeled with these zones since this defies specific quantification for the user. Bottom label 1508 shows the student's performance broken down by total questions, real questions and experimental questions. The student's score is converted to a percentile using industry standard parameters for the test. Pull down 1509 changes the background of the app to different skins to optimize use for different color backgrounds. This makes intensive work on a computer easier because taking standardized tests involves staring at a screen for up to 4 hours with limited breaks. Redundant scrolling mechanism 1510 scrolls between diagnostic pages. In this embodiment there are six pages: adaptive chart, pacing chart, strengths and weaknesses, question types and a traditional explanation page. This design allows the users to see all the different graph page representations of their results. Trophy display 1511 is optimized to render near the final dot to display the final score. It renders at the conclusion of the loading animation in 1506. 1512 illustrates a dot that was clicked earlier; Since dots are carried over from graph to graph, it is shaded here. The shading effect carries to prevent confusion of re-clicking the same dot on different diagnostic graphs. The clicking of these dots may be saved and recalled to the database so that the user knows which explanations he has already viewed. This is essential to prevent confusion since the same interactive points are in each graph. The downside of multiple interactive representation of performance is that the user may get confused, but questions clicked assume different visual traits and may be toggle flagged by the user as is standard in the art to prevent this confusion.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood by one of ordinary skill that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, micro-controllers, embedded micro-controllers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a tangible computer readable storage medium that is not a transitory propagating signal, said medium encoding computer-readable instructions, and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include computers of various types, whether the computer architecture may be of Harvard, von Neumann, or any other architecture, or combination of architectures.

Regardless of the type of computer program or computer involved, a computer program can be loaded onto a computer to produce a particular machine that can perform any and all of the described functions. This particular machine provides a means for carrying out any and all of the described functions.

Any combination of one or more computer readable medium(s) may be utilized. A computer readable medium may be: a computer readable signal transmission medium; or, a tangible computer readable storage medium that is not a transitory propagating signal. A tangible computer readable storage medium that is not a transitory propagating signal may encode computer-readable instructions that, when applied to a computer system, instruct the computer system to perform one or more methods, processes, operations, or steps, as disclosed herein. A tangible computer readable storage medium that is not a transitory propagating signal may be, for example, but not limited to, a portable computer diskette, a hard disk, a random access memory (RAM), a read-only memory (ROM), an erasable programmable read-only memory (EPROM or Flash memory), a portable compact disc read-only memory (CD-ROM), or any suitable combination of the foregoing. In the context of this document, a computer readable storage medium may be any tangible computer readable storage medium that is not a transitory propagating signal and that can contain, or store a program for use by or in connection with an instruction execution system, apparatus, or device.

Computer program instructions can be stored in a computer-readable non-transitory memory capable of directing a computer or other programmable data processing apparatus to function in a particular manner. The instructions stored in the computer-readable non-transitory memory constitute an article of manufacture including computer-readable instructions for implementing any and all of the depicted functions.

The elements depicted in flowchart illustrations and block diagrams throughout the figures imply logical boundaries between the elements, however, a system or method implemented with a different physical or actual partitioning of the elements than shown in a flowchart or block diagram will not depart from the teachings herein. In addition, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

It will be appreciated that computer program instructions may include computer executable code. A variety of languages for expressing computer program instructions are possible, including without limitation C, C++, C#, Java, JavaScript, Ruby, Python, assembly language, Lisp, markup languages such as HTML, SGML, XML, and so on. Such languages may include assembly languages, hardware description languages, database programming languages, functional programming languages, imperative programming languages, and so on. In some embodiments, computer program instructions can be stored, compiled, dynamically or statically linked as an application with zero or more libraries, or interpreted to run on a computer, a programmable data processing apparatus, a heterogeneous combination of processors or processor architectures, and so on.

In some embodiments, a computer enables execution of computer program instructions including multiple programs or threads. The multiple programs or threads may be processed in parallel to enhance utilization of the processor and to facilitate concurrent functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to comprise: execute, process, interpret, compile, assemble, link, load, any and all combinations of the foregoing, or the like, as needed to complete the operation of computer program instructions. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to implementation and operation using a wide variety of computer network systems over numerous topologies, including but not limited to standalone host computers, client-server architectures, distributed architectures using a plurality of networks, a plurality of host computers communicating via said plurality of networks, cloud architectures, cluster architectures, and the like. Within this field, the configuration and management of large networks include storage devices and computers that are communicatively coupled to dissimilar computers and storage devices over a network, such as the Internet.

The present embodiments are to be considered as illustrative and not restrictive, and the invention is not to be limited to the details given herein. It is therefore intended that the disclosure and any following claims be interpreted as covering all such alterations and modifications as fall within the true spirit and scope of the invention. It is appreciated that certain features of the invention, which are, for clarity, described herein in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention.

What is claimed is:

1. A method for improving pace and performance on a test, the method comprising:
building one or more databases containing a plurality of test questions and associated data, said associated data including: time spent by previous test takers answering each of the said plurality of test questions, and correct answers to each of the said plurality of test questions;
determining a normal question pace time for answering each of the said plurality of test questions;
determining as configured test conditions including: number of questions for test, and time limit for test;
calculating pace time as a global variable equal to the time limit for test divided by the number of questions for test;
determining as configured a test type including: adaptive or non-adaptive;
upon determining the test type is adaptive, initializing an adaptive question selection algorithm to estimate the test taker's skill level;
upon determining the test type is non-adaptive, not initializing an adaptive question selection algorithm to estimate the test taker's skill level;
determining as configured if the test includes experimental questions;
upon determining the test includes experimental questions; selecting as configured: a first database of non-experimental test questions, and, a second database of experimental test questions;
upon determining the test does not include experimental questions; selecting as configured: a database of non-experimental test questions;
starting a pace tracking timer;
administering a test of said test questions to a test taker, wherein for each of the said plurality of test questions of said test administering a test of said test questions to a test taker includes:
choosing from said one or more databases one selected test question;
presenting said selected test question to a test taker to be answered;
recording from said pace tracking timer the test taker start time answering said selected test question;
recording the test taker's response to said selected test question;
recording from said pace tracking timer the test taker end time answering said selected test question;
computing the measured test taker's response time from the said test taker end time and said test taker start time;
checking the test taker's response to said selected test question for accuracy;
computing the test taker's pace time as a global variable for test taker's current time elapsed;
comparing said test taker's time spent on said selected test question to average time for said selected test question, wherein said average time per said selected test question may be adjusted for the test taker skill level and similar skill levels or background data on the test taker;
providing a pace indicator which compares the amount of time spent by test taker on said selected test question to the normal pace for answering said selected test questions;
providing feedback;
recording results;
determining if said test is complete;
upon determining said test is not complete, administer the next question of said test by choosing from said one or more databases one selected test question; and
upon determining said test is complete, displaying results.

2. A computer readable storage medium that is not a transitory propagating signal, encoding computer readable instructions including processor executable program instructions, wherein said processor executable program instructions, when executed by one or more processor, cause the one or more processor to perform operations comprising:
building one or more databases containing a plurality of test questions and associated data, said associated data including: time spent by previous test takers answering each of the said plurality of test questions, and correct answers to each of the said plurality of test questions;
determining a normal question pace time for answering each of the said plurality of test questions;
determining as configured test conditions including: number of questions for test, and time limit for test;
calculating pace time as a global variable equal to the time limit for test divided by the number of questions for test;
determining as configured a test type including: adaptive or non-adaptive;
upon determining the test type is adaptive, initializing an adaptive question selection algorithm to estimate the test taker's skill level;
upon determining the test type is non-adaptive, not initializing an adaptive question selection algorithm to estimate the test taker's skill level;
determining as configured if the test includes experimental questions;
upon determining the test includes experimental questions; selecting as configured: a first database of non-experimental test questions, and, a second database of experimental test questions;
upon determining the test does not include experimental questions; selecting as configured: a database of non-experimental test questions;
starting a pace tracking timer;
administering a test of said test questions to a test taker, wherein for each of the said plurality of test questions of said test administering a test of said test questions to a test taker includes:
choosing from said one or more databases one selected test question;
presenting said selected test question to a test taker to be answered;
recording from said pace tracking timer the test taker start time answering said selected test question;
recording the test taker's response to said selected test question;
recording from said pace tracking timer the test taker end time answering said selected test question;
computing the measured test taker's response time from the said test taker end time and said test taker start time;
checking the test taker's response to said selected test question for accuracy;
computing the test taker's pace time as a global variable for test taker's current time elapsed;
comparing said test taker's time spent on said selected test question to average time for said selected test question, wherein said average time per said selected test question may be adjusted for the test taker skill level and similar skill levels or background data on the test taker;
providing a pace indicator which compares the amount of time spent by test taker on said selected test question to the normal pace for answering said selected test questions;
providing feedback;
recording results;
determining if said test is complete;
upon determining said test is not complete, administer the next question of said test by choosing from said one or more databases one selected test question; and
upon determining said test is complete, displaying results.

3. A test preparation system, comprising:
one or more processor;
a computer readable storage medium that is not a transitory propagating signal, encoding computer readable instructions including processor executable program instructions accessible to said one or more processor, wherein said processor executable program instructions, when executed by said one or more processor, cause the one or more processor to perform operations comprising:
building one or more databases containing a plurality of test questions and associated data, said associated data including: time spent by previous test takers answering each of the said plurality of test questions, and correct answers to each of the said plurality of test questions;
determining a normal question pace time for answering each of the said plurality of test questions;
determining as configured test conditions including: number of questions for test, and time limit for test;
calculating pace time as a global variable equal to the time limit for test divided by the number of questions for test;
determining as configured a test type including: adaptive or non-adaptive;
upon determining the test type is adaptive, initializing an adaptive question selection algorithm to estimate the test taker's skill level;
upon determining the test type is non-adaptive, not initializing an adaptive question selection algorithm to estimate the test taker's skill level;
determining as configured if the test includes experimental questions;
upon determining the test includes experimental questions; selecting as configured: a first database of non-experimental test questions, and, a second database of experimental test questions;
upon determining the test does not include experimental questions; selecting as configured: a database of non-experimental test questions;
starting a pace tracking timer;
administering a test of said test questions to a test taker, wherein for each of the said plurality of test questions of said test administering a test of said test questions to a test taker includes:
choosing from said one or more databases one selected test question;
presenting said selected test question to a test taker to be answered;
recording from said pace tracking timer the test taker start time answering said selected test question;
recording the test taker's response to said selected test question;
recording from said pace tracking timer the test taker end time answering said selected test question;
computing the measured test taker's response time from the said test taker end time and said test taker start time;
checking the test taker's response to said selected test question for accuracy;
computing the test taker's pace time as a global variable for test taker's current time elapsed;
comparing said test taker's time spent on said selected test question to average time for said selected test question, wherein said average time per said selected test question may be adjusted for the test taker skill level and similar skill levels or background data on the test taker;
providing a pace indicator which compares the amount of time spent by test taker on said selected test question to the normal pace for answering said selected test questions;
providing feedback;
recording results;
determining if said test is complete;
upon determining said test is not complete, administer the next question of said test by choosing from said one or more databases one selected test question; and
upon determining said test is complete, displaying results.
